(19) United States
(12) Patent Application Publication
(10) Pub. No.: US 2026/0143389 A1
(43) Pub. Date: May 21, 2026

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Ce ZHENG, Beijing (CN); Chen SUN, Beijing (CN)

(73) Assignee: Sony Group Corporation, Tokyo (JP)

(21) Appl. No.: 19/119,774

(22) PCT Filed: Oct. 13, 2023
(86) PCT No.: PCT/CN2023/124431

§ 371 Date: Apr. 10, 2025

(30) Foreign Application Priority Data
Oct. 20, 2022 (CN) 202211286543.5

(51) Int. Cl. H04W 36/00; H04W 52/36; H04W 76/38

(52) U.S. Cl. CPC H04W 36/008357; H04W 52/367; H04W 76/38

(57) ABSTRACT

The present application relates to an electronic device and method for wireless communication, and a computer-readable storage medium. The electronic device for wireless communication comprises a processing circuit. The processing circuit is configured to control, on the basis of the capability of a node and/or an electronic device among a plurality of nodes involved in a predetermined task, at least one of the access of the node in the predetermined task, the exit of the node in the predetermined task and the switching of the electronic device in the predetermined task. (FIG. 1)

This application claims priority to Chinese Patent Application No. 202211286543.5 titled “ELECTRONIC DEVICE AND METHOD FOR WIRELESS COMMUNICATION, AND COMPUTER-READABLE STORAGE MEDIUM”, filed on Oct. 20, 2022 with the China National Intellectual Property Administration (CNIPA), which is incorporated herein by reference in its entirety.

### FIELD

The present disclosure relates to the technical field of wireless communications, and in particular to an electronic apparatus and a method for wireless communications and a computer-readable storage medium. More specifically, the present disclosure relates to at least one of: access and exit in a predetermined task of a node participating in the predetermined task, and switching in a predetermined task of a control node in the predetermined task.

### BACKGROUND

Execution of a predetermined task is significantly affected by a time of access and/or exit in the predetermined task of a node participating in the predetermined task, and/or a time of switching in the predetermined task of a control node in the predetermined task.

How to improve a service guarantee mechanism for a predetermined task is a research hotspot at present.

### SUMMARY

A brief summary of the present disclosure is given below, to provide a basic understanding of some aspects of the present disclosure. It should be understood that the following summary is not an exhaustive summary of the present disclosure. It is not intended to determine a key or important part of the present disclosure, nor does it intend to limit the scope of the present disclosure. The purpose is merely to present some concepts in a simplified form, as a preamble to a more detailed description discussed later.

According to an aspect of the present disclosure, an electronic apparatus for wireless communications is provided. The electronic apparatus includes processing circuitry, configured to: control, based on capability of a node among a plurality of nodes involved in a predetermined task and/or the electronic apparatus, at least one of access of the node in the predetermined task, exit of the node in the predetermined task, and switching of the electronic apparatus in the predetermined task.

In embodiments according to the present disclosure, the electronic apparatus performs the above-described control based on a capability of a node among a plurality of nodes involved in the predetermined task and/or the electronic apparatus, so that service guarantee for the predetermined task is improved.

According an aspect of the present disclosure, an electronic apparatus for wireless communications is provided. The electronic apparatus includes processing circuitry, configured to: report capability of the electronic apparatus to a central node in a predetermined task in which the electronic apparatus is involved, for the central node to control access and/or exit of the electronic apparatus in the predetermined task.

In embodiments according to the present disclosure, the electronic apparatus reports the capability of the electronic apparatus to the central node in the predetermined task in which the electronic apparatus is involved, for the central node to perform the control, so that service guarantee for the predetermined task is improved.

According to an aspect of the present disclosure, a method for wireless communications is provided. The method includes: controlling, by an electronic apparatus based on capability of a node among a plurality of nodes involved in a predetermined task and/or the electronic apparatus, at least one of access of the node in the predetermined task, exit of the node in the predetermined task, and switching of the electronic apparatus in the predetermined task.

According to an aspect of the present disclosure, a method for wireless communications is provided. The method includes: reporting capability of an electronic apparatus to a central node in a predetermined task in which the electronic apparatus is involved, for the central node to control access and/or exit of the electronic apparatus in the predetermined task.

According to other aspects of the present disclosure, there are further provided a computer program code and a computer program product for implementing the above-described methods for wireless communication, and a computer-readable storage medium having the computer program code for implementing the methods for wireless communications recorded thereon.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an electronic apparatus for wireless communications according to an embodiment of the present disclosure;

FIG. 2 is a diagram illustrating an example of a client-server federated learning network;

FIG. 3 is a diagram illustrating an example of a federated learning network having a P2P structure;

FIG. 4 shows an example of determining when an electronic apparatus performs the switching according to an embodiment of the present disclosure;

FIG. 5 shows another example of determining when an electronic apparatus performs the switching according to an embodiment of the present disclosure;

FIG. 6 shows yet another example of determining when an electronic apparatus performs the switching according to an embodiment of the present disclosure;

FIG. 7 shows an example of switching of a central aggregation node according to a conventional technology;

FIG. 8 shows an example of determining when an node to be accessed performs access according to an embodiment of the present disclosure;

FIG. 9 shows another example of determining when an node to be accessed performs access according to an embodiment of the present disclosure;

FIG. 10 shows an example of an node to be accessed accessing a network according to a conventional technology;

FIG. 11 shows an example of determining when a node to be exited performs exit according to an embodiment of the present disclosure;

FIG. 12 shows another example of determining when a node to be exited performs exit according to an embodiment of the present disclosure;

FIG. 13 shows yet another example of determining when a node to be exited performs exit according to an embodiment of the present disclosure;

FIG. 14 shows an example of a node to be exited exiting a network according to a conventional technology;

FIG. 15 shows a block diagram of functional modules of an electronic apparatus for wireless communications according to a further embodiment of the present disclosure;

FIG. 16 shows a flow chart of a method for wireless communications according to an embodiment of the present disclosure;

FIG. 17 shows a flow chart of a method for wireless communications according to another embodiment of the present disclosure;

FIG. 18 is a block diagram showing a first example of a schematic configuration of an eNB or gNB to which the technology of the present disclosure is applicable;

FIG. 19 is a block diagram showing a second example of a schematic configuration of an eNB or gNB to which the technology of the present disclosure is applicable;

FIG. 20 is a block diagram showing an example of a schematic configuration of a smart phone to which the technology of the present disclosure is applicable;

FIG. 21 is a block diagram showing an example of a schematic configuration of an automobile navigation device to which the technology of the present disclosure is applicable; and

FIG. 22 is a block diagram of an exemplary structure of a universal personal computer in which the methods and/or apparatuses and/or systems according to the embodiments of the present disclosure can be implemented.

### DETAILED DESCRIPTION

Hereinafter, exemplary embodiments of the present disclosure will be described in conjunction with the accompanying drawings. For the sake of clarity and conciseness, not all features of an actual embodiment are described in the specification. However, it is to be appreciated that numerous implementation-specific decisions shall be made while implementing any of such actual embodiments so as to achieve specific objectives of a developer, for example, to comply with system- and business-related constraining conditions which vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

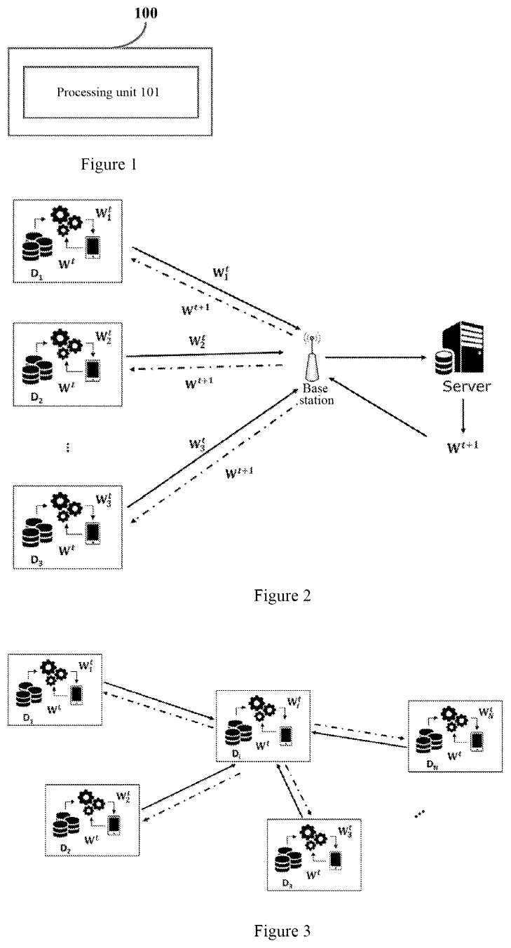

FIG. 1 shows a block diagram of functional modules of an electronic apparatus 100 for wireless communications according to an embodiment of the present disclosure.

As shown in FIG. 1, the electronic apparatus 100 includes a processing unit 101. The processing unit 101 may control, based on capability of a node among a plurality of nodes involved in a predetermined task and/or the electronic apparatus 100, at least one of access (joining) of the node in the predetermined task, exit of the node in the predetermined task, and switching of the electronic apparatus 100 in the predetermined task

The processing unit 101 may be implemented by one or more processing circuits. The processing circuitry may be implemented as a chip, for example.

The electronic apparatus 100 may serve as a network-side apparatus in a wireless communication system, and may be specifically provided on a base station side or be communicatively connected to a base station, for example. Here, it should be noted that the electronic apparatus 100 may be implemented at a chip level or at an apparatus level. For example, the electronic apparatus 100 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment (UE), another base station, and the like). An implementation of the transceiver is not specifically limited here.

As an example, the network-side apparatus may be a base station, which may be an eNB or gNB, for example.

As an example, the network-side apparatus may be a server.

In addition, the electronic apparatus 100 may, for example, be provided on a user equipment (UE) side or be communicatively connected to the user equipment. In a case where the electronic apparatus 100 is provided on the user equipment side or communicatively connected to the user equipment, an apparatus related to the electronic apparatus 100 may be user equipment. Here, it should be noted that the electronic apparatus 100 may be implemented at a chip level or at an apparatus level. For example, the electronic apparatus 100 may operate as the user equipment itself and may further include a memory, a transceiver (not shown), and other external devices. The memory may store related data information and programs that the user equipment needs to execute to achieve various functions. The transceiver may include one or more communication interfaces to support communications with different devices (such as a base station, another UE, and the like). An implementation of the transceiver is not specifically limited here.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art may understand that the wireless communication system according to the present disclosure may be a 4G or 3G communication system.

In embodiments according to the present disclosure, the electronic apparatus 100 performs the above-described control based on a capability of a node among a plurality of nodes involved in the predetermined task and/or the electronic apparatus 100, so that service guarantee for the predetermined task is improved.

As an example, the predetermined task includes a federated learning task. The processing unit 101 may be configured to: send, in each round of the federated learning task, a result of a total task in a previous round to a plurality of nodes, for the plurality of nodes to perform respective subtasks (in an initial round, the result of a total task is a preset value or random value); and integrate based on results of respective subtasks reported by the plurality of nodes respectively, to obtain an integrated result as an updated result of the total task in a current round.

In a case where the predetermined task is a federated learning task, in a first round, the electronic apparatus 100 sends a parameter of an initial global model (i.e., a result related to a total task) to the nodes. The nodes train and update local models (i.e., perform subtasks) based on the initial global model using data stored locally to obtain parameters of learned local models (i.e., results of the subtasks), and upload the parameters of the learned local models to the electronic apparatus 100 (for example, in each round, a node upload a parameter of a local model to the electronic apparatus 100 every time the node performs k iterations). The electronic apparatus 100 performs integration (aggregation) based on the parameters of the local models (i.e., the results of the subtasks) reported by the nodes, to obtain an updated parameter of the initial global model (i.e., an updated result of the total task). In a subsequent round, the electronic apparatus 100 sends the updated parameter of the global model to the nodes. The nodes train and update the local model (i.e., perform subtasks) based on the updated parameter of the global model using data stored locally, to obtain updated parameters of the local models (i.e., results of the subtasks), and upload the updated parameters of the local models to the electronic apparatus 100. The electronic apparatus 100 performs integration (aggregation) based on the updated parameters of the local models reported by the nodes to obtain an updated parameter of the global model (i.e., an updated result of the total task). By analogy, the predetermined task ends when a predetermined condition is met. For example, the predetermined condition includes that a global loss function convergence or reaches an ideal training accuracy.

In the following, sending of a parameter of the initial global model by the electronic apparatus 100 is sometimes referred to as sending of a global model, uploading of a parameter of the local model by a node is referred to as uploading of the local model, and aggregation by the electronic apparatus 100 to obtain a parameter of the global model is referred to as aggregation of a global model or global aggregation.

The federated learning task may include, for example, a federated learning task in a centralized mode and a federated learning task having a peer-to-peer (P2P) structure.

The federated learning task in a centralized mode includes a central aggregation node and multiple computing UEs (user equipment). The computing UE performs at least one of the following operations: being responsible for training and update of the local model; and the central aggregation node is responsible for aggregation of the global model. For example, the computing UE is configured to: collect local data; receive a global model from the central aggregation node; train and update the local model based on the local data; report the trained local model to the central aggregation node; estimate state information of the UE (for example, channel state information between the UE and the central aggregation node, location information of the UE, computing capability information (such as CPU usage), battery level, and memory capacity); estimate time-related information of training and update of the local model; report the state information of the UE and the time-related information to the central aggregation node; report a request, such as for joining or exiting training of the federated learning, to the central aggregation node; and accept and execute a decision from the central aggregation node. For example, the central aggregation node performs at least one of the following operations: receiving the local model from the computing UE; aggregating the global model; delivering the global model to each computing UE; estimating time information related to aggregation; and receiving the request of the computing UE and making a decision.

In the federated learning task in a centralized model, the central node is a server or a base station, for example.

For example, a client-server federated learning network is an example of the federated learning task in a centralized mode.

FIG. 2 is a diagram illustrating an example of a client-server federated learning network.

As shown in FIG. 2, it is assumed that there are N nodes. For simplicity, in FIG. 2, set N=3, that is, there are three nodes D₁, D₂ and D₃. Those skilled in the art may understand that N may be any positive integer greater than or equal to 3. A federated learning process of the client-server federated learning network is as follows. (1) Each node accesses the server through a wireless channel, and obtains a parameter (for example, w^{t}) of an initial global model through downlink transmission of the server (although FIG. 2 shows that each node is connected to the server through a base station, those skilled in the art may understand that the node may be directly connected to the server. (2) Each node performs learning on the local model based on w^{t} and using data stored locally, to complete one or more iterative updates of the local model. (3) Each node uploads the learned parameters

$${W}_{1}^{t} , {W}_{2}^{t} and {W}_{3}^{t}$$

of the local model to the server through uplink. The server performs aggregation

$${W}^{t + 1} = {\sum }_{n = 1}^{N} {p}_{n} {W}_{n}^{t}$$

on collected parameters of local models from nodes, to complete aggregation of a global model, where pₙ represents a weight coefficient of the n-th node. (4) The server delivers the parameter w^{t+1} of the updated global model (aggregated global model) to the nodes. Steps (2) to (4) are repeated until the global model converges.

In the client-server federated learning network, performance of the server becomes a bottleneck of the federated learning.

The federated learning task in a P2P structure is similar to the federated learning task in a centralized mode. A difference is that the central aggregation node in the federated learning task in a centralized mode is implemented by a computing UE in the federated learning task in a P2P structure. For example, the federated learning network in a P2P structure consists of multiple computing UEs, one of which serves as a central UE to implement the function of the central aggregation node. Each computing UE is responsible for training and update of a local model. The central UE is responsible for aggregation of a global model. In addition, the central UE can implement the function of the computing UE. For example, the computing UE performs at least one of the following operations: collecting local data; receiving a global model from the central UE; training and updating the local model based on the local data; reporting the trained local model to the central UE; estimating state information of the UE (for example, at least one of channel state information between the UE and the central aggregation node, location information of the UE, computing capability information (such as CPU usage), battery level, memory capacity, or size of a data sample of the UE); estimating time-related information of training and update of the local model; reporting the state information of the UE and the time-related information to the central UE; reporting a request, such as for joining or exiting the federated learning, to the central UE; and receiving and executing a decision from the central UE. The central UE performs at least one of the following operations: receiving the local model from the computing UE; aggregating the global model; delivering the global model to each computing UE; estimating time information related to aggregation; and receiving the request of other node and making a decision. In the federated learning network in a P2P structure, each UE is able to serve as a computing UE or a central UE. However, during each training process, there is only one central UE in the network. The central UE may serve as a computing UE for training of a local model during the federated learning process. Each UE may be directly connected through P2P (for example, device-to-device D2D, such as sidelink).

FIG. 3 is a diagram illustrating an example of a federated learning network having a P2P structure.

The federated learning network shown in FIG. 3 includes N UEs, that is, there are N nodes D₁, D₂, . . . , and D_{N}. The UE may be a terminal device such as a mobile phone, an iPad, or a notebook, or may be a vehicle, an UAV (unmanned aerial vehicle), and the like. A UE (for example, Dᵢ) is selected from N UEs in the federated learning network shown in FIG. 3 as a central UE, which is responsible for aggregation of a global model. The function is similar or identical to the server in FIG. 2. The other UEs serve as computing UEs. All the UEs (including the central UE) may perform training and update of local models respectively based on local data. The central UE receives local models from the computing UEs to perform aggregation and update of the global model.

For example, according to an SGD (Gradient Descent) algorithm, a federated learning process of a P2P structured federated learning network may include the following steps. (1) A certain UE in the network randomly serves as a central UE to first initiate a training request, initializes a parameter of a global model, and broadcasts the parameter of the initial global model to other UEs (computing UEs) in the network. On reception of the training request, each computing UE determines whether to join the training of the federated learning. If joins, the computing UE receives the initial global model. (2) The computing UE performs training and update of a local model based on local data. (3) The computing UEs upload updated parameters

$${W}_{1}^{t} , {W}_{2}^{t} , … , {W}_{i}^{t} , … , {W}_{N}^{t}$$

of the local models to the central node, respectively. (4) The central node performs aggregation of a global model after receiving the updated parameters of the local models from all the UEs, to obtain an updated parameter

$${W}^{t + 1} = {\sum }_{n = 1}^{N} {p}_{n} {W}_{n}^{t}$$

of the global model. (5) The central node broadcasts and delivers the parameter of the updated global model (global model obtained from aggregation) to the computing UEs. Steps (2) to (5) are repeated until the central UE switches or a new UE joins or a computing UEs in training leaves or the model converges.

In the following, the electronic apparatus 100 is sometimes referred to as a central aggregation node or central UE or central node, and a node is sometimes referred to as a computing UE.

As an example, the predetermined task includes a distributed task, and the processing unit 101 may be configured to split a total task in the distributed task into multiple subtasks. The processing unit 101 may be further configured to: send, in an initial round, an initial result of the total task to the plurality of nodes; send, in each round rather than the initial round, a result of the total task in a previous round to the plurality of nodes, for the plurality of nodes to perform respective subtasks; and integrate based on results of respective subtasks reported by the plurality of nodes respectively, to obtain an integrated result as an updated result of the total task in a current round.

For example, an example of the distributed task is distributed computing MapReduce. The MapReduce includes two core stages, i.e., Map and Reduce. The Map stage corresponds to the “split”, in which a complex total task is decomposed into several “simple subtasks” for execution (corresponding to the calculation and update of local models in the federated learning). The Reduce stage corresponds to the “integrate”, in which results in the Map stage are summarized (corresponding to the aggregation of a global model in the federated learning).

For example, in the distributed computing MapReduce, the electronic apparatus 100 (the central node) splits a large-scale total task into multiple subtasks for execution on computing UEs. An execution process on the total task may include the following steps. (1) Each computing UE uploads a result to the central node after executing the subtask to a certain extent, and the central node performs processing and integration after receiving results uploaded by all computing UEs. (2) The central node continues to allocate subtasks to the computing UEs. (3) Steps (1) and (2) are repeated until the total task is completed.

In the following, the federated learning task is described as an example, for convenience. Those skilled in the art may understand that these examples are similarly applicable to other distributed tasks besides the federated learning task.

As an example, the capability of the node and/or the electronic apparatus 100 is characterized by time information about the node and/or the electronic apparatus 100.

As the capability of the node and/or the electronic apparatus 100 is characterized by the time information, the electronic apparatus 100 can perform the above control simply and intuitively.

As an example, the time information of a node and/or the electronic apparatus 100 is estimated based on at least one of channel state information, location information, battery level, and computing capability of the node and/or the electronic apparatus 100.

As an example, the processing unit 101 may be configured to: in response to a switching request for the switching issued by the electronic apparatus 100, perform the control based on a remaining control time length of the electronic apparatus 100 in a current round included in the time information, to determine when the electronic apparatus 100 switches to not perform the control in the predetermined task. Here, the remaining control time length is equal to a small one of a remaining service time length from a current time instant to a time instant when the electronic apparatus 100 no longer performs the control and a time length from a current time instant to an end time instant of a current control cycle of the electronic apparatus 100.

In the following description, that the electronic apparatus 100 no longer performs the control may be referred to as that the electronic apparatus 100 is unable to provide service in the network, that is, unable to provide service related to the predetermined task.

In the electronic apparatus 100 according to the embodiment of the present disclosure, by determining when the electronic device 100 switches to not perform the control in the predetermined task based on the remaining control time length of the electronic apparatus 100 in a current round, a low probability of service interruption in the network can be realized and waste of resources is avoided.

For a network structure of a federated learning task in a centralized mode, the central aggregation node may be a fixed and stable gNB, or may be a mobile and unstable vehicle, drone, or the like. In a case where the gNB has a low battery level or fails, switching of the central aggregation node may occur. When a vehicle, drone, or the like, move as a central aggregation node, switching of the central aggregation node may occur.

For a federated learning network having a P2P structure, any of the nodes constituting the network may serve as a central UE. Therefore, a node having a strong capability in computing and communication may be selected as the central UE, and thus switching of the central UE may occur.

For a network structure of a distributed task, the central UE may switch among nodes constituting the network.

It is assumed that the central aggregation node or central UE has a service period (control period) τₛ, that is, an automatic switching occurs when the service time (control time) exceeds τₛ. For a case where the central aggregation node is a base station, it may be considered that τₛ=∞ is satisfied.

In the following, Tᵣₑₘₐᵢₙ represents a remaining time that the electronic apparatus 100 provides service, that is, a remaining service time length from a current time to a time instant when the electronic apparatus 100 is unable to perform the control (in other words, an estimated value of a time length from a current time to a time instant when the electronic apparatus 100 is unable to provide service). It should be noted that the inability of the electronic apparatus 100 to provide service refers to a fact that the electronic apparatus 100 is unable to provide service due to the computing capability or communication capability, rather than a situation that a service time exceeds Ts.

Further, τᵣₑₘₐᵢₙ represents a remaining time of specified service of the electronic apparatus 100, that is, a time length of a current time instant to an end time instant of a current control cycle of the electronic apparatus 100 (in other words, an estimated value of a time length from a current time instant to an end time instant of the service period Ts).

Further, Tₘᵢₙ represents a remaining control time length of the electronic apparatus 100 in a current round, Tₘᵢₙ=min [Tᵣₑₘₐᵢₙ, τᵣₑₘₐᵢₙ], that is, Tₘᵢₙ is equal to a minimum value from Tᵣₑₘₐᵢₙ and τᵣₑₘₐᵢₙ.

For example, the electronic apparatus 100 may estimate a connection time between the electronic apparatus 100 and a computing UE based on location information included in channel state information of the electronic apparatus 100 and/or channel state information reported by the computing UE, and thereby estimate the Tᵣₑₘₐᵢₙ Or Tₘᵢₙ. For example, electronic apparatus 100 may estimate the Tᵣₑₘₐᵢₙ based on a battery level of the electronic apparatus 100. For example, the electronic apparatus 100 may estimate a computing time of the electronic apparatus 100 based on a computing capability of the electronic apparatus 100, and thereby estimate the time for the electronic apparatus 100 to complete global aggregation in a current round. For example, in a federated learning network having a P2P structure, the electronic apparatus 100 may estimate a computing time of the electronic apparatus 100 based on a computing capability of the electronic apparatus 100 and a size of data sample, and thereby estimate the time for the electronic apparatus 100 to complete global aggregation in a current round.

As an example, the processing unit 101 may be configured to perform the determination further based on a first time length and a second time length included in the time information, the first time length referring to a time length from a current time instant to a time instant when the electronic apparatus 100 completes integration in a next round, and the second time length referring to a time length from a current time instant to a time instant when the electronic apparatus 100 completes integration in a current round.

In the electronic apparatus 100 according to the embodiment of the present disclosure, the first time length and the second time length are used to further determine when the electronic apparatus 100 switches to not perform control in the predetermined task, so that the electronic apparatus 100 can be selected or guaranteed to perform the switching after completion of aggregation of the global model. Hence, all nodes in the network share a same global model, and waste of resources is further avoided.

Here, T₁ represents a remaining time required for the electronic apparatus 100 from a current time instant to completion of global aggregation in a current round, that is, the second time length (in other words, a time period from a current time instant to a time instant when the electronic apparatus 100 completes the current round of global aggregation).

Here, T₂ represents a time required for the electronic apparatus 100 from completion of global aggregation in a current round to completion of global aggregation in a next round.

Here, Tₜᵣₐᵢₙ represents a remaining time required by the electronic apparatus 100 from a current time instant to completion of global aggregation in a next round, where Tₜᵣₐᵢₙ=T₁+T₂, that is, the first time length (in other words, from a current time instant to a time instant when the electronic apparatus 100 completes the next round of global aggregation).

As an example, the processing unit 101 may be configured to determine that the electronic apparatus 100 does not perform the switching before completion of integration in a next round, in a case where the remaining control time length Tₘᵢₙ is greater than or equal to the first time length Tₜᵣₐᵢₙ.

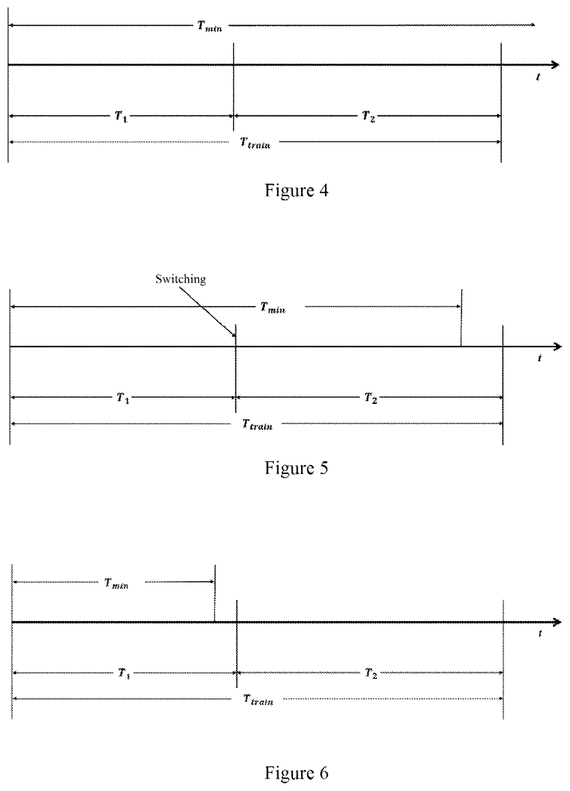

FIG. 4 shows an example of determining when an electronic apparatus 100 performs switching according to an embodiment of the present disclosure. In FIG. 4, there has Tₘᵢₙ>Tₜᵣₐᵢₙ, and the electronic apparatus 100 does not perform switching before completing integration in a next round.

As an example, the processing unit 101 may be configured to determine that the electronic apparatus 100 performs the switching immediately after completion of integration in a current round, in a case where the remaining control time length Tₘᵢₙ is greater than the second time length T₁ and less than the first time length Tₜᵣₐᵢₙ.

FIG. 5 shows another example of determining when an electronic apparatus 100 performs switching according to an embodiment of the present disclosure. In FIG. 5, there has T₁<Tₘᵢₙ<Tₜᵣₐᵢₙ, that is, the electronic apparatus 100 is able to participate in aggregation of a global model in a current round, but its residence time does not support a next round of aggregation of the global model. Hence, the electronic apparatus 100 performs the switching immediately after completing aggregation of a global model in a current round.

As an example, the processing unit 101 may be configured to extend the remaining service time length Tₘᵢₙ in a case where the remaining control time length Tₘᵢₙ is less than or equal to the second time length T₁, through at least one of the following manners: increasing a transmitted power of the electronic apparatus 100, reducing a reference signal received power (RSRP) threshold of the electronic apparatus 100, and allocating more communication resources to the electronic apparatus 100.

FIG. 6 shows yet another example of determining when an electronic apparatus 100 performs switching according to an embodiment of the present disclosure. In FIG. 6, Tₘᵢₙ≤T₁, that is, the electronic apparatus 100 is unable to normally complete aggregation of the global model in a current round, and the electronic apparatus 100 attempts to extend the remaining service time length Tₘᵢₙ. For example, it is attempted to realize an extended remaining control time length which is greater than the second time length T₁, that is, enable the electronic apparatus 100 to perform the switching after a current round of global aggregation is completed, so that service is guaranteed.

As an example, the processing unit 101 may be configured to determine that the electronic apparatus 100 performs the switching immediately after completion of integration in a current round, in a case where the extended remaining control time length is greater than the second time length T₁.

As an example, the processing unit 101 may be configured to determine that the electronic apparatus 100 performs the switching during the extended remaining control time length from a current time instant, in a case where the extended remaining control time length is less than or equal to the second time length T₁. As an example, after the electronic apparatus 100 performs the switching, a node configured for performing the control in the predetermined task (that is, a new central aggregation node or central UE after switching, referred to as a new control node) broadcasts an instruction to the nodes requiring the nodes to report results of respective subtasks, to receive the results of the respective subtasks from the nodes. A computing UE that has uploaded a local model to the electronic apparatus 100 before the switching and a computing UE that is uploading a local model to the electronic apparatus 100 need to reupload the local models to the new control node. For example, the new control node broadcasts an instruction to computing UEs, requiring the computing UEs to report local models. Specifically, a computing UE that has uploaded a local model to the electronic apparatus 100 and a computing UE that is uploading a local model to the electronic apparatus 100 reupload the local models to the new control node; and a computing UE that has not uploaded a local model to the electronic apparatus 100 uploads the local model to the new control node.

The above describes an example of controlling a time of switching of the electronic apparatus 100 according to an embodiment of the present disclosure.

On the contrary, in the conventional technology, there is no limit on the time of switching of a central aggregation node or central node, which may result in failure in completing aggregation of a global model.

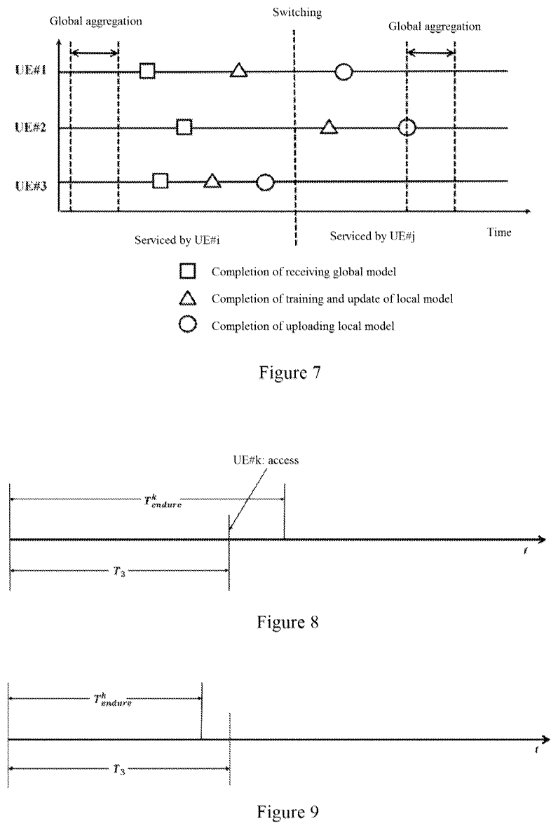

FIG. 7 shows an example of switching of a central aggregation node according to a conventional technology.

In FIG. 7, it is assumed that a central aggregation node in service is UE #i, and a central aggregation node will provide service is UE #j. That is, after service of UE #i ends, UE #j continues to serve as a central aggregation node to provide aggregation service. If there is no limit on a time of switching the central aggregation node, there is a situation where some computing UEs upload local models to UE #i while other computing UEs upload local models to UE #j during the switching. As shown in FIG. 7, UE #3 has completed training and update of a local model before the switching, and therefore UE #3 uploads the local model to UE #i, while UE #1 and UE #2 upload models to UE #j. That is, the local models were uploaded to two different places (UE #i and UE #j), and therefore aggregation of the global model cannot be completed.

As an example, the processing unit 101 may be configured to: in response to an access request for the access issued by an node to be accessed tending to access the predetermined task, perform the control based on a maximum waiting time length acceptable for the node to be accessed to access the predetermined task included in the time information, to determine when the node to be accessed performs the access.

In the electronic apparatus 100 according to the embodiment of the present disclosure, by controlling based on the maximum waiting time length to determine when the node to be accessed performs the access, it can be avoided that the electronic apparatus 100 separately sends the global model to the node to be accessed and consumes extra communication resources, and interference with transmission of other business information in the network can be avoided.

For example,

$${T}_{endure}^{k}$$

represents the maximum waiting time length, and k represents an index number of an node to be accessed to the predetermined task.

As an example, the processing unit 101 may be configured to perform the determination further based on a third time length included in the time information, the third time length referring to a time length from a time instant when the node to be accessed issues the access request to a time instant when the electronic apparatus 100 completes integration in a current round.

The third time length is represented as T₃.

In the electronic apparatus 100 according to the embodiment of the present disclosure, by further determining when the node to be accessed performs the access based on the third time length, the node to be accessed can be selected or guaranteed to access the network after aggregation of the global model is completed. Thereby, it is further avoided that the electronic apparatus 100 separately sends the global model to the node to be accessed and consumes extra communication resources, and interference with transmission of other business information in the network is further avoided. In addition, it can be avoided that addition of node to be accessed lengthens the time for aggregation of the global model in a current round.

As an example, the processing unit 101 may be configured to determine that the node to be accessed performs the access after the electronic apparatus 100 completes integration in a current round and before the electronic apparatus 100 broadcasts an integrated result in a current round, in a case where the maximum waiting time length

$${T}_{endure}^{k}$$

is greater than or equal to the third time length T₃.

FIG. 8 shows an example of determining when an node to be accessed performs access according to an embodiment of the present disclosure.

As shown in FIG. 8, there has

$${T}_{endure}^{k} \geq {T}_{3} ,$$

an node to be accessed UE #k is able to tolerate waiting until the end of the current round of global aggregation and perform access.

The electronic apparatus 100 determines that the node to be accessed UE #k accesses after integration in a current round and before the electronic apparatus 100 broadcasts an integrated result in a current round.

As an example, the processing unit 101 may be configured to broadcast an integrated result in a current round after the node to be accessed performs the access. After accessing the network, UE #k receives the global model broadcast by the electronic apparatus 100, and performs training of the federated learning together with other UEs.

As an example, the processing unit 101 may be configured to: in a case where the maximum waiting time length

$${T}_{endure}^{k}$$

is less than the third time length T₃, during a period of the maximum waiting time length

$${T}_{endure}^{k}$$

from a time instant when the node to be accessed issues the access request, issue an instruction requiring all nodes participating in the predetermined task to report results of respective subtasks in a current round at a time instant of receipt of the instruction, receive results of respective subtasks in a current round reported by all nodes participating in the predetermined task, and determine that the node to be accessed performs the access during the maximum waiting time length

$${T}_{endure}^{k} ,$$

after the electronic apparatus 100 completes integration in a current round and before the electronic apparatus 100 broadcasts an integrated result in a current round. As an example, the processing unit 101 may be configured to broadcast an integrated result in a current round after the node to be accessed performs the access.

FIG. 9 shows another example of determining when an node to be accessed performs access according to an embodiment of the present disclosure.

As shown in FIG. 9, there has

$${T}_{endure}^{k} < {T}_{3} ,$$

an node to be accessed UE #k is unable to tolerate waiting until the end of the current round of global aggregation before accessing. In this case, during the maximum waiting time length from a time instant when the node to be accessed UE #k issues the access request, the electronic apparatus 100 sends an instruction requiring computing UE(s) participating in the predetermined task to upload current local model(s). A UE that has not completed update of the local model in the current round needs to upload only a current result. For example, a round of training and update of a local model includes k times of training of the local model. Assuming that a certain UE completes only k₁<k times of training when receiving the upload instruction, the UE reports the k₁-th result. The electronic apparatus 100 performs forced aggregation based on received local models, and determines that UE #k accesses after aggregation in the current round and before the electronic apparatus 100 broadcasts an integrated result in the current round.

When the electronic apparatus 100 sends an instruction requiring the computing UEs participating in the predetermined task to upload current local models, a UE that has completed upload of update of a local model in the current round does not need to upload again.

As an example, the processing unit 101 may be configured to: in a case where the maximum waiting time length

$${T}_{endure}^{k}$$

is less than the third time length T₃, determine that the node to be accessed performs the access during the maximum waiting time length from a time instant of issuing the access request, and deliver an integrated result in a previous round to the node to be accessed. For example, in a case of

$${T}_{endure}^{k} < {T}_{3} ,$$

the electronic apparatus 100 may separately deliver the global model in a previous round to UE #k, and UE #k directly participates in the current round of training of federated learning.

The above describes an example of controlling when an node to be accessed accesses a network in the electronic apparatus 100 according to an embodiment of the present disclosure.

In the conventional technology, there is no control over when the node to be accessed accesses a network.

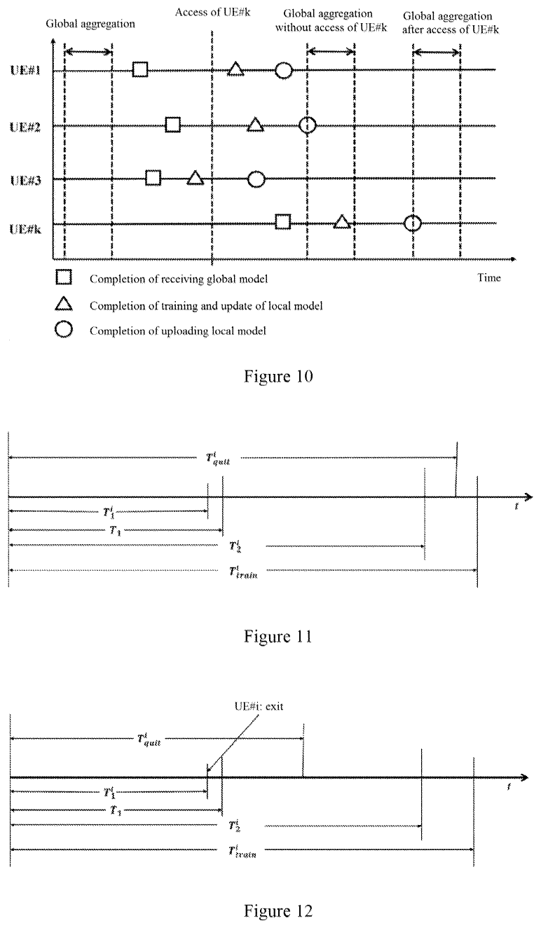

FIG. 10 shows an example of an node to be accessed accessing a network according to a conventional technology. As shown in FIG. 10, UE #k joins the network during a learning process. In this case, the central aggregation node needs to send a global model to UE #k separately, which consumes additional communication resources and may cause interference in other business information in the network. In addition, the addition of UE #k may prolong the time for the round of global aggregation. For example, compared with the time for “global aggregation without UE #k access”, the time for “global aggregation after UE #k access” in FIG. 10 is later. Especially when other local models of calculating UEs are about to be uploaded, the addition of UE #k may lengthen the time for the current round of global aggregation.

As an example, the processing unit 101 may be configured to: in response to an exit request for the exit issued by a node to be exited tending to exit the predetermined task, perform the control based on a disconnection waiting time length from a time instant when the node to be exited issues the exit request to a time instant when the node to be exited is unable to participate in the predetermined task included in the time information, to determine when the node to be exited performs the exit.

It is assumed that

$${T}_{quit}^{i}$$

represents the disconnection waiting time length of a node to be exited UE #i.

For example, the inability of the node to be exited UE #i to participate in the predetermined task may refer to disconnection of a communication connection between the node to be exited UE #i and the electronic apparatus 100, or may be disconnection caused by other condition of the UE #i itself (such as insufficient battery).

In the electronic apparatus 100 according to an embodiment of the present disclosure, by determining when the node to be exited performs the exit based on the disconnection waiting time length, transmission interruption during the process of the node to be exited uploading a local model can be avoided, and thereby waste of computing resources or communication resources is avoided.

As an example, the processing unit 101 may be configured to determine when the node to be exited performs the exit further based on a fourth time length and a fifth time length, the fourth time length referring to a time length from a time instant when the node to be exited issues the exit request to a time instant when the node to be exited completes reporting of results of respective subtasks in a next round, and the fifth time length referring to a time length from a time instant when the node to be exited issues the exit request to a time instant when the node to be exited completes reporting of results of respective subtasks in a current round.

It is assumed that

$${T}_{2}^{i}$$

represents the fourth time length (i.e., an estimated time length from a time instant when the node to be exited UE #i issues the exit request to a time instant of completion of uploading the local model to the electronic apparatus 100 in a next round). There has

$${T}_{2}^{i} \leq {T}_{train}^{i} ,$$

where

$${T}_{train}^{i}$$

represents an estimated ume length from a time instant when the node to be exited UE #i issues the exit request to a time instant of completion of a next round of global aggregation by the electronic apparatus 100. It is assumed that

$${T}_{1}^{i}$$

represents the fifth time length (i.e., an estimated time length from a time instant when the node to be exited UE #i issues the exit request to a time instant of completion of uploading the local model to the electronic apparatus 100 in a current round). There has

$${T}_{1}^{i} \leq {T}_{1} .$$

In the electronic apparatus 100 according to the embodiment of the present disclosure, by further determining when the node to be exited performs the exit based on the fourth time length and the fifth time length, the node to be exited can be selected or guaranteed to exit after the local model is successfully uploaded. Hence, transmission interruption during the process of the node to be exited uploading the local model is further avoided.

As an example, the processing unit 101 may be configured to: determine that the node to be exited UE #i does not perform the exit before completion of reporting results of respective subtasks in a next round, in a case where the disconnection waiting time length

$${T}_{quit}^{i}$$

is greater than or equal to the fourth time length

$${T}_{2}^{i} .$$

FIG. 11 shows an example of determining when a node to be exited performs exit according to an embodiment of the present disclosure.

As shown in FIG. 11, there has

$${T}_{quit}^{i} \geq {T}_{2}^{i} ,$$

it is determined that a node to be exited UE #i may exit after completion of a next round of training and update of a local model and uploading to the electronic apparatus 100.

As an example, the processing unit 101 may be configured to: determine that the node to be exited UE #i performs the exit after completion of reporting results of respective subtasks in a current round, in a case where the disconnection waiting time length

$${T}_{quit}^{i}$$

is greater than the fifth time length

$${T}_{1}^{i}$$

and less than the fourth time length

$${T}_{2}^{i} .$$

FIG. 12 shows another example of determining when a node to be exited performs exit according to an embodiment of the present disclosure.

As shown in FIG. 12, there has

$${T}_{1}^{i} < {T}_{quit}^{i} < {T}_{2}^{i} ,$$

a node to be exited UE #i is able to complete a current round (but unable to complete a next round) of training and update of a local model, and upload to the electronic apparatus 100. It is determined that the node to be exited UE #i may perform the exit after completion of reporting a local model in a current round. In this case, the electronic apparatus 100 can obtain the local model of UE #i, and the UE #i does not perform redundant operations. Hence, computing resources or communication resources is not wasted.

As an example, the processing unit 101 may be configured to delay the disconnection waiting time length

$${T}_{quit}^{i}$$

in a case where the disconnection waiting time length

$${T}_{quit}^{i}$$

is less than or equal to the fifth time length

$${T}_{1}^{i} ,$$

by delaying the time instant when the node to be exited is unable to participate in the predetermined task through at least one of the following manners: increasing a transmitted power of the node to be exited, reducing a reference signal received power RSRP threshold of the node to be exited, and allocating more communication resources to the node to be exited.

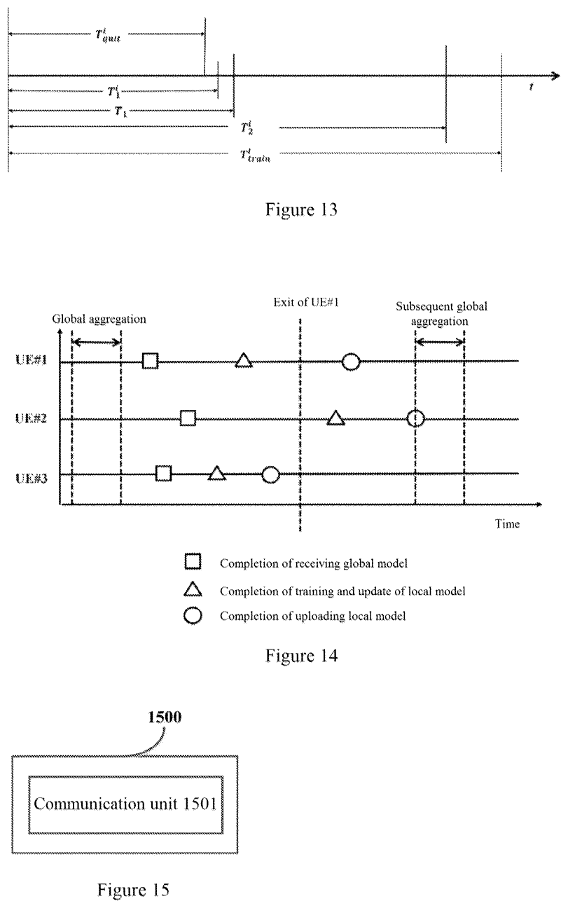

FIG. 13 shows yet another example of determining when a node to be exited performs exit according to an embodiment of the present disclosure.

As shown in FIG. 13, there has

$${T}_{quit}^{i} \leq {T}_{1}^{i} ,$$

a node to be exited UE #i is unable to completely participate in global aggregation in a current round. The electronic apparatus 100 may delay the disconnection waiting time length

$${T}_{quit}^{i} ,$$

to enable the node to be exited UE #i complete reporting a local model in a current round, so that the reported local model is usable for global aggregation in the current round.

As an example, the processing unit 101 may be configured to: determine that the node to be exited UE #i performs the exit after completion of reporting results of respective subtasks in a current round, in a case where the delayed disconnection waiting time length is greater than the fifth time length

$${T}_{1}^{i} .$$

As an example, the processing unit 101 may be configured to: in a case where the delayed disconnection waiting time length is less than or equal to the fifth time length

$${T}_{1}^{i} ,$$

issue an instruction requiring all nodes participating in the predetermined task to report results of respective subtasks in a current round at a time instant of receipt of the instruction; during a period of the delayed disconnection waiting time length from a time instant when the node to be exited issues the exit request, receive results of respective subtasks in a current round reported by all nodes participating in the predetermined task, and determine that the node to be exited performs the exit after completion of reporting results of respective subtasks in a current round. That is, in a case where the delayed disconnection waiting time length is still less than or equal to the fifth time length

$${T}_{1}^{i} ,$$

the electronic apparatus 100 may send an upload instruction requiring all the computing UEs to upload current local models, and perform enforced aggregation after the current local models uploaded by the computing UEs are received. For example, a round of update of a local model includes k times of training of the local model. Assuming that a computing UE UE #j completes only k₁<k times of training when receiving the upload instruction, the computing UE UE #j reports the k₁-th training result. The node to be exited UE #i exits after uploading the current local model. In this case, the electronic apparatus 100 may obtain the local model of the node to be exited UE #i, and the node to be exited UE #i does not perform redundant operations.

As an example, the processing unit 101 may be configured to: in a case where the delayed disconnection waiting time length is less than or equal to the fifth time length

$${T}_{1}^{i} ,$$

issue an instruction requiring the node to be exited to report results of respective subtasks in a current round at a time instant of receipt of the instruction, and determine that the node to be exited performs the exit after completion of reporting results of respective subtasks in a current round. That is, in a case where the delayed disconnection waiting time length is still less than or equal to the fifth time length

$${T}_{1}^{i} ,$$

the electronic apparatus 100 may instruct the node to be exited UE #i to perform the exit immediately after uploading the current local model.

The above describes an example of controlling when a node to be exited exits a network in the electronic apparatus 100 according to an embodiment of the present disclosure.

In the conventional technology, there is no control over when the node to be exited exits a network.

FIG. 14 shows an example of a node to be exited exiting a network according to a conventional technology. As shown in FIG. 14, UE #1 exits before a local model is uploaded. At this time, the transmission of the local model uploaded by UE #1 is interrupted, resulting in a waste of computing resources and communication resources at UE #1. A main reason is that UE #1 has completed the training and update of the local model through calculation, and uplink resources are allocated to UE #1 and UE #1 occupies the uplink resources, but the local model of UE #1 is not used for subsequent global aggregation.

As an example, the capability of the node and/or the electronic apparatus 100 is characterized by battery level information of the node and/or the electronic apparatus 100.

As an example, the capability of the node and/or the electronic apparatus 100 is characterized by location information of the node and/or the electronic apparatus 100.

In conjunction with the above description, those skilled in the art can envisage examples of performing the above-described control based on the capability of the apparatus 100 through the battery level information or location information of the node and/or the electronic apparatus 100, which are not described in detail here.

As an example, the processing unit 101 may be configured to deliver a result of the control to the node via a Uu port in a case where the federated learning is in a centralized mode in which the electronic apparatus 100 is a base station.

As an example, the processing unit 101 may be configured to deliver a result of the control to the node via a PC5 port (such as a sidelink) in a case where the federated learning is in a centralized mode in which the electronic apparatus 100 is a roadside apparatus or a vehicle-mounted apparatus.

As an example, the processing unit 101 may be configured to deliver a result of the control to the node via a PC5 port (such as a sidelink) in a case where the federated learning has a peer-to-peer structure.

The above interaction between the node and the electronic apparatus 100 may be implemented through various existing appropriate signaling processes. For example, the interaction between the node and the electronic apparatus 100 may be implemented through RRC (Radio Resource Control), MAC-CE (Control Element for Media Access Control), DCI (Downlink Control Information), and other signaling. In addition, those skilled in the art may envisage that the signaling may be used in description of other communication standards in the future.

As an example, the processing unit 101 may be configured to deliver a result of the control to the node through RRC signaling. Those skilled in the art may further understand that the electronic apparatus 100 may deliver a result of the control to the node through other signaling, which is not described in detail here.

As an example, the processing unit 101 may be configured to receive information about the capability from the node periodically or through event triggering.

As an example, the event triggering includes that a battery level of the node is lower than a predetermined threshold.

For example, in a federated learning network in a centralized mode, a base station indicates current scheduling information to a UE (a node participating in a predetermined task) through a physical downlink control (PDCCH) channel during initial scheduling. In a case where the UE identifies that the scheduling is semi-static scheduling (SPS), the UE stores the current scheduling information and transmit or receive service data at a same time-frequency resource location with a fixed period. In this way, PDCCH resources used for scheduling indication can be saved.

The SPS may be used for periodic reporting of time or state information (for example, battery level information or location information). The reporting of an event or state information caused by event triggering may be implemented by dynamic scheduling.

For example, period information of the SPS may be obtained through a 5G core network such as a network exposure function. Based on the period information, the electronic device 100 described above controls switching, access and exit of nodes (users) participating in the federated learning task.

As an example, the predetermined task includes beam selection or usage of resources in a resource pool.

In a case where the federated learning task is applied to a physical layer, for example, when used to train an artificial intelligence model for UE beam selection or usage of resources in a resource pool, the UE may obtain physical resources allocated by the SPS of each UE to implement the federated learning at the physical layer. Periodic information of the SPS is configured by a base station to the UE. For example, the UE receives the SPS information through RRC signaling. On reception of resource activation information sent by the base station, the UE may use the allocated physical layer transmission resources. Therefore, the UE knows in advance the communication resources the UE can possess through the SPS information obtained through RRC. Such information may be interacted between UEs so that the control mechanism manages dynamic participation in the federated learning tasks of the UEs based on the SPS information of each UE.

An electronic apparatus for wireless communications is further provided according to another embodiment of the present disclosure. FIG. 15 shows a block diagram of functional modules of an electronic apparatus 1500 for wireless communications according to a further embodiment of the present disclosure.

As shown in FIG. 15, the electronic apparatus 1500 includes a communication unit 1501. The communication unit 1501 may report capability of the electronic apparatus 1500 to a central node in a predetermined task in which the electronic apparatus 1500 is involved, for the central node to control access and/or exit of the electronic apparatus 1500 in the predetermined task.

The communication unit 1501 may be implemented by one or more processing circuits. The processing circuitry may be implemented as a chip, for example.

The electronic apparatus 1500 may, for example, be provided on a user equipment (UE) side or be communicatively connected to the user equipment. In a case where the electronic apparatus 1500 is provided on the user equipment side or communicatively connected to the user equipment, an apparatus related to the electronic apparatus 1500 may be user equipment. Here, it should be noted that the electronic apparatus 1500 may be implemented at a chip level or at an apparatus level. For example, the electronic apparatus 1500 may operate as the user equipment itself and may further include a memory, a transceiver (not shown), and other external devices. The memory may store related data information and programs that the user equipment needs to execute to achieve various functions. The transceiver may include one or more communication interfaces to support communications with different devices (such as a base station, another UE, and the like). An implementation of the transceiver is not specifically limited here.

As an example, the central node may be the electronic apparatus 100 mentioned above. As an example, the electronic apparatus 1500 may be the user equipment involved in the above embodiments of the electronic apparatus 100.

The wireless communication system according to the present disclosure may be a 5G NR communication system. Further, the wireless communication system according to the present disclosure may include a non-terrestrial network. Alternatively, the wireless communication system according to the present disclosure may further include a terrestrial network. In addition, those skilled in the art may understand that the wireless communication system according to the present disclosure may be a 4G or 3G communication system.

In embodiments according to the present disclosure, the electronic apparatus 1500 reports the capability of the electronic apparatus 1500 to the central node, for the central node to control the access and/or exit of the electronic apparatus 1500 in the predetermined task, so that service guarantee for the predetermined task is improved.

As an example, the predetermined task includes a federated learning task, and the communication unit 1501 may be configured to: receive, in each round of the federated learning task, a result of a total task in a previous round from the central node to perform respective subtasks; and report results of respective subtasks to the central node, for the central node to integrate based on results of respective subtasks to obtain an integrated result as an updated result of the total task in a current round.

As an example, the predetermined task includes a distributed task, and the communication unit 1501 may be configured to: receive, in each round, a result of a total task in a previous round from the central node to perform respective subtasks; and report results of respective subtasks to the central node, for the central node to integrate based on results of respective subtasks to obtain an integrated result as an updated result of the total task in a current round.

For relevant examples of the federated learning task, reference may be made to the description in conjunction with FIG. 2 and FIG. 3 in the embodiments of the electronic apparatus 100, which is not repeated here.

For examples of a distributed task, reference may be made to description of corresponding sections in the embodiment of the electronic apparatus 100, which is not repeated here.

As an example, the capability is characterized by time information about the electronic apparatus 1500.

The time information is estimated based on at least one of channel state information, location information, battery level, and computing capability of the electronic apparatus 1500.

As an example, the communication unit 1501 may be configured to: issue an access request for the access to the central node, for the central node to perform the control based on a maximum waiting time length acceptable for the electronic apparatus 1500 to access the predetermined task included in the time information, to determine when the electronic apparatus 1500 performs the access.

As an example, the time information further includes a third time length, referring to a time length from a time instant when the electronic apparatus 1500 issues the access request to a time instant when the central node completes integration in a current round.

As an example, the communication unit 1501 may be configured to receive, from the central node, a decision that: the electronic apparatus 1500 performs the access after the central node completes integration in a current round and before the central node broadcasts an integrated result in a current round, in a case where the maximum waiting time length is greater than or equal to the third time length. As an example, the communication unit 1501 may be configured to receive, after performing the access, an integrated result in a current round broadcast by the central node. For relevant examples, reference may be made to the description in conjunction with FIG. 8 in the embodiments of the electronic apparatus 100, which is not repeated here.

As an example, the communication unit 1501 may be configured to receive, from the central node, a decision that: in a case where the maximum waiting time length is less than the third time length, during a period of the maximum waiting time length from a time instant when the electronic apparatus 1500 issues the access request, the central node issues an instruction requiring all nodes participating in the predetermined task to report results of respective subtasks in a current round at a time instant of receipt of the instruction, receives results of respective subtasks in a current round reported by all nodes participating in the predetermined task, and the electronic apparatus 1500 performs the access during the maximum waiting time length, and after the central node completes integration in a current round and before the central node broadcasts an integrated result in a current round. As an example, the communication unit 1501 may be configured to broadcast an integrated result in a current round after the electronic apparatus 1500 performs the access. For relevant examples, reference may be made to the description in conjunction with FIG. 9 in the embodiments of the electronic apparatus 100, which is not repeated here.

As an example, the communication unit 1501 may be configured to receive, from the central node, a decision that: in a case where the maximum waiting time length is less than the third time length, the electronic apparatus 1500 performs the access during the maximum waiting time length from a time instant of issuing the access request, and receives an integrated result in a previous round from the central node. For relevant examples, reference may be made to the description in conjunction with FIG. 9 in the embodiments of the electronic apparatus 100, which is not repeated here.

As an example, the communication unit 1501 may be configured to: issue an exit request for the exit to the central node, for the central node to perform the control based on a disconnection waiting time length from a time instant when the electronic apparatus 1500 issues the exit request to a time instant when the electronic apparatus is unable to participate in the predetermined task included in the time information, to determine when the electronic apparatus 1500 performs the exit.

As an example, the time information further includes a fourth time length and a fifth time length, the fourth time length referring to a time length from a time instant when the electronic apparatus 1500 issues the exit request to a time instant when the electronic apparatus completes reporting of results of respective subtasks in a next round, and the fifth time length referring to a time length from a time instant when the electronic apparatus 1500 issues the exit request to a time instant when the electronic apparatus completes reporting of results of respective subtasks in a current round.

As an example, the communication unit 1501 may be configured to receive, from the central node, a decision that: the electronic apparatus 1500 does not perform the exit before completion of reporting results of respective subtasks in a next round, in a case where the disconnection waiting time length is greater than or equal to the fourth time length. For relevant examples, reference may be made to the description in conjunction with FIG. 11 in the embodiments of the electronic apparatus 100, which is not repeated here.

As an example, the communication unit 1501 may be configured to receive, from the central node, a decision that: the electronic apparatus 1500 performs the exit after completion of reporting results of respective subtasks in a current round, in a case where the disconnection waiting time length is greater than the fifth time length and less than the fourth time length. For relevant examples, reference may be made to the description in conjunction with FIG. 12 in the embodiments of the electronic apparatus 100, which is not repeated here.

As an example, the disconnection waiting time length may be delayed in a case where the disconnection waiting time length is less than or equal to the fifth time length, by delaying the time instant when the electronic apparatus is unable to participate in the predetermined task through at least one of the following manners: increasing a transmitted power of the electronic apparatus 1500, reducing a reference signal received power RSRP threshold of the electronic apparatus 1500, and allocating more communication resources to the electronic apparatus 1500. For relevant examples, reference may be made to the description in conjunction with FIG. 13 in the embodiments of the electronic apparatus 100, which is not repeated here.

As an example, the communication unit 1501 may be configured to receive, from the central node, a decision that: the electronic apparatus 1500 performs the exit after completion of reporting results of respective subtasks in a current round, in a case where the delayed disconnection waiting time length is greater than the fifth time length.

As an example, the communication unit 1501 may be configured to receive, from the central node, a decision that: in a case where the delayed disconnection waiting time length is less than or equal to the fifth time length, during a period of the delayed disconnection waiting time length from a time instant when the electronic apparatus 1500 issues the exit request, the central node issues an instruction requiring all nodes participating in the predetermined task to report results of respective subtasks in a current round at a time instant of receipt of the instruction, receives results of respective subtasks in a current round reported by all nodes participating in the predetermined task, and the electronic apparatus 1500 performs the exit after completion of reporting results of respective subtasks in a current round.

As an example, the communication unit 1501 may be configured to receive, from the central node, a decision that: in a case where the delayed disconnection waiting time length is less than or equal to the fifth time length, the central node issues an instruction requiring the electronic apparatus 1500 to report results of respective subtasks in a current round at a time instant of receipt of the instruction, and the electronic apparatus 1500 performs the exit after completion of reporting results of respective subtasks in a current round.

As an example, the capability of the electronic apparatus 1500 is characterized by battery level information or location information of the electronic apparatus 1500.

As an example, the communication unit 1501 may be configured to receive a result of the control from the central node via a Uu port in a case where the federated learning is in a centralized mode in which the central node is a base station.

As an example, the communication unit 1501 may be configured to receive a result of the control from the central node via a PC5 port in a case where the federated learning is in a centralized mode in which the central node is a roadside apparatus or a vehicle-mounted apparatus.

As an example, the communication unit 1501 may be configured to receive a result of the control from the central node via a PC5 port in a case where the federated learning has a peer-to-peer structure.

As an example, the communication unit 1501 may be configured to report information about the capability to the central node periodically or through event triggering.

As an example, the event triggering includes that a battery level of the electronic apparatus 1500 is lower than a predetermined threshold.

As an example, the predetermined task includes beam selection or usage of resources in a resource pool.

In the description of the electronic apparatuses for wireless communications in the above embodiments, some processes or methods are further disclosed. Hereinafter, an overview of the methods is given without repeating some of details discussed above. It should be noted that although disclosed in the description of the electronic apparatuses for wireless communication, the methods do not necessarily adopt the components as described or be performed by those components. For example, an embodiment of the electronic apparatus for wireless communications may be implemented partially or entirely using hardware and/or firmware, while a method for wireless communications discussed below may be implemented entirely by a computer-executable program, although the method may employ the hardware and/or firmware for the electronic apparatus for wireless communication.

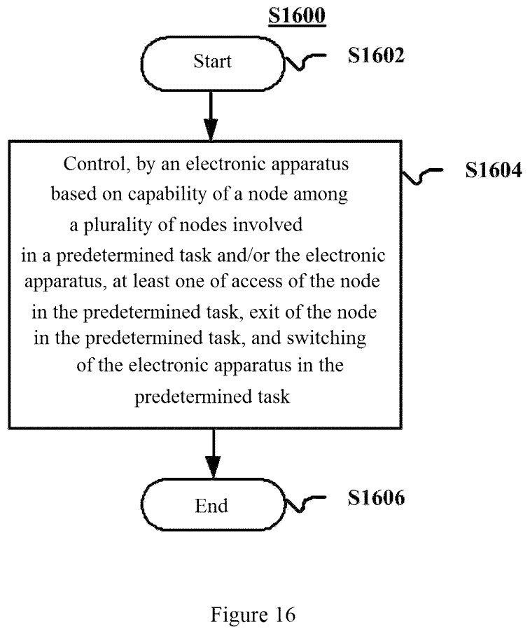

FIG. 16 shows a flow chart of a method S1600 for wireless communications according to an embodiment of the present disclosure. The method S1600 starts from step S1602. In step 1604, an electronic apparatus controls, based on capability of a node among a plurality of nodes involved in a predetermined task and/or the electronic apparatus, at least one of access of the node in the predetermined task, exit of the node in the predetermined task, and switching of the electronic apparatus in the predetermined task. The method S1600 ends at step S1606.

This method may be performed, for example, by the electronic apparatus 100 as described above. For specific details, reference may be made to the description of relevant processes of the electronic apparatus 100, which is not repeated here.

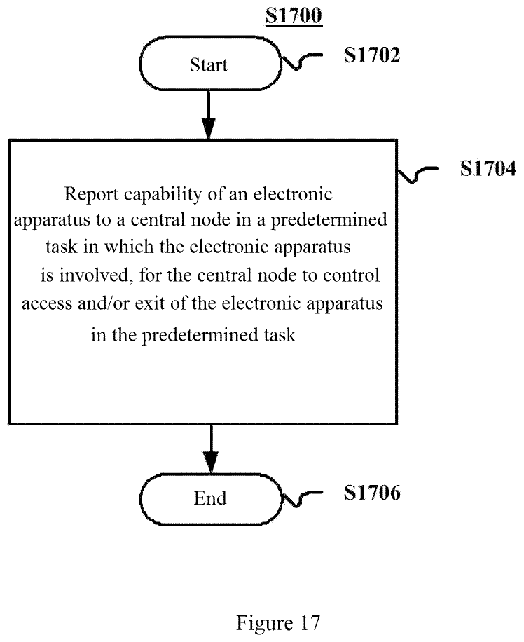

FIG. 17 shows a flow chart of a method S1700 for wireless communications according to an embodiment of the present disclosure. The method S1700 starts from step S1702. In step S1704, capability of an electronic apparatus is reported to a central node in a predetermined task in which the electronic apparatus is involved, for the central node to control access and/or exit of the electronic apparatus in the predetermined task. The method S1700 ends at step S1706.

This method may be performed, for example, by the electronic apparatus 1500 as described above. For specific details, reference may be made to the description of relevant processes of the electronic apparatus 1500, which is not repeated here.

The technology of the present disclosure is applicable to various products.

The electronic apparatus 100 may be implemented as various network-side apparatuses, such as a base station. The base station may be implemented as any type of evolved Node B (eNB) or gNB (5G base station). An eNB includes, for example, a macro eNB and a small eNB. The small eNB may be an eNB covering a cell smaller than a macro cell, such as a pico eNB, a micro eNB, or a home (femto) eNB. A similar situation may apply to the gNB. Alternatively, the base station may be implemented as any other type of base station, such as a NodeB or a base transceiver station (BTS). The base station may include a body (which is also referred to as base station equipment) configured to control wireless communications and one or more remote radio heads (RRHs) arranged at a different place from the body. In addition, various types of electronic apparatuses can all operate as base stations by temporarily or semi-persistently performing base station functions.

The electronic apparatus 100 may be implemented as various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may be implemented as a terminal that performs machine-to-machine (M2M) communications (which is also referred to as a machine type communication (MTC) terminal). Furthermore, the user equipment may be a wireless communication module (such as an integrated circuit module including a single chip) installed on each of the above-mentioned terminals.

The electronic apparatus 1500 may be implemented as various user equipment.

### APPLICATION EXAMPLES OF BASE STATION

### First Application Example

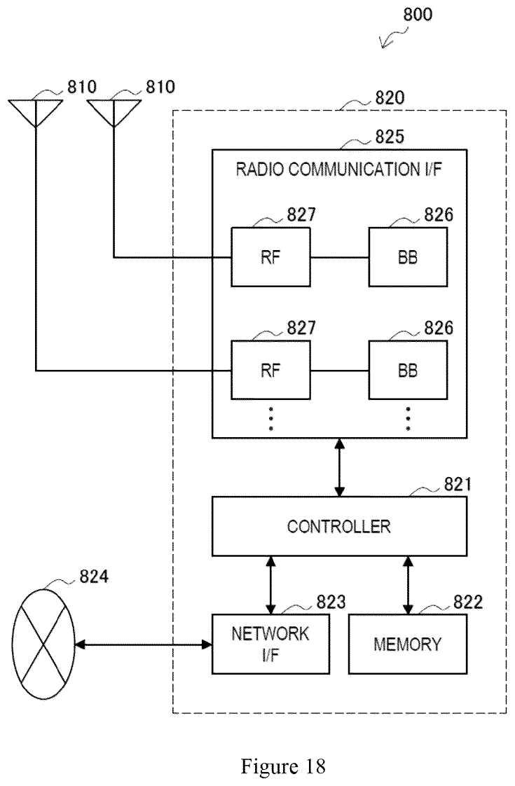

FIG. 18 is a block diagram showing a first example of a schematic configuration of an eNB or gNB to which the technology of the present disclosure is applicable. It should be noted that the following description is made taking an eNB as an example. The technology of the present disclosure is also applicable to a gNB. An eNB 800 includes one or more antennas 810 and base station equipment 820. The base station equipment 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station equipment 820 to transmit and receive wireless signals. As shown in FIG. 18, the eNB 800 may include multiple antennas 810. For example, the multiple antennas 810 may be compatible with multiple frequency bands used by the eNB 800. Although FIG. 18 shows an example in which the eNB 800 includes multiple antennas 810, the eNB 800 may include a single antenna 810.

The base station equipment 820 includes a controller 821, a memory 822, a network interface 823, and a radio communication interface 825.

The controller 821 may be, for example, a CPU or DSP, and operates various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or another eNB may be connected to each other through a logical interface (such as an SI interface and an X2 interface). The network interface 823 may be a wired communication interface or a radio communication interface for a wireless backhaul line. In a case that the network interface 823 is a radio communication interface, the network interface 823 may use a higher frequency band for wireless communications than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 826 and an RF circuit 87. The BB processor 826 may perform, for example, coding/decoding, modulation/demodulation and multiplexing/de-multiplexing, and perform various types of signal processes of layers (for example, layer 1, media access control (MAC), radio link control (RLC) and packet data convergence protocol (PDCP)). Instead of the controller 821, the BB processor 826 may have a part or all of the above-mentioned logical functions. The BB processor 826 may be a memory storing a communication control program, or a module including a processor and a related circuit configured to execute the program. Updating the program may change the functions of the BB processor 826. The module may be a card or blade inserted into a slot of the base station equipment 820. Alternatively, the module may be a chip mounted on the card or blade. In addition, the RF circuit 87 may include, for example, a mixer, a filter and an amplifier, and transmit and receive a wireless signal via the antenna 810.

As shown in FIG. 18, the radio communication interface 825 may include multiple BB processors 826. For example, the multiple BB processors 826 may be compatible with multiple frequency bands used by the eNB 800. As shown in FIG. 18, the radio communication interface 825 may include multiple RF circuits 87. For example, the multiple RF circuits 87 may be compatible with multiple antenna elements. Although FIG. 18 shows an example in which the radio communication interface 825 includes multiple BB processors 826 and multiple RF circuits 87, the radio communication interface 825 may include a single BB processor 826 or a single RF circuit 87.

In the eNB 800 as shown in FIG. 18, the electronic apparatus 100, when implemented as a base station, has a transceiver that may be implemented by the radio communication interface 825. At least a part of the functions may be implemented by the controller 821. For example, the controller 821 may perform the division and joint training by performing functions of the units in the electronic apparatus 100.

### Second Application Example

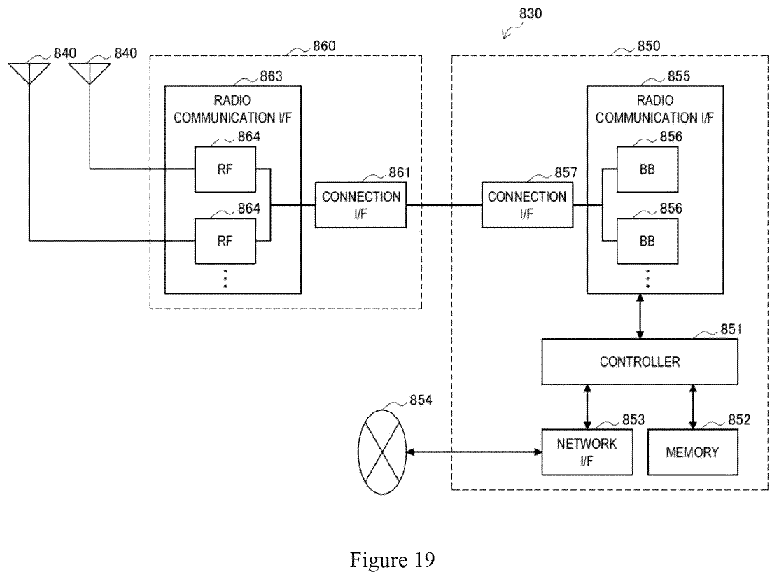

FIG. 19 is a block diagram showing a second example of a schematic configuration of an eNB or gNB to which the technology of the present disclosure is applicable. It should be noted that the following description is made taking the eNB as an example. The technology of the present disclosure is also applicable to the gNB. An eNB 830 includes a single or multiple antennas 840, base station equipment 850 and an RRH 860. The RRH 860 and each of the antennas 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 19, the eNB 830 may include multiple antennas 840. For example, the multiple antennas 840 may be compatible with multiple frequency bands used by the eNB 830. Although FIG. 19 shows an example in which the eNB 830 includes multiple antennas 840, the eNB 830 may include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 18.

The radio communication interface 855 supports any cellular communication scheme (such as LTE and LTE-advanced), and provides wireless communications to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 18, except that the BB processor 856 is connected to an RF circuit 864 of the RRH 860 via the connection interface 857. As shown in FIG. 19, the radio communication interface 855 may include multiple BB processors 856. For example, the multiple BB processors 856 may be compatible with multiple frequency bands used by the eNB 830. Although FIG. 19 shows an example in which the radio communication interface 855 includes multiple BB processors 856, the radio communication interface 855 may include a single BB processor 856.

The connection interface 857 is an interface for connecting the base station equipment 850 (the radio communication interface 855) to the RRH 860. The connection interface 857 may be a communication module for communication in the above-described high-speed line that connects the base station equipment 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station equipment 850. The connection interface 861 may be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 19, the radio communication interface 863 may include multiple RF circuits 864. For example, the multiple RF circuits 864 may support multiple antenna elements. Although FIG. 19 shows an example in which the radio communication interface 863 includes multiple RF circuits 864, the radio communication interface 863 may include a single RF circuit 864.

In the eNB 830 as shown in FIG. 19, the electronic apparatus 100, when implemented as a base station, has a transceiver that may be implemented by the radio communication interface 855. At least a part of the functions may be implemented by the controller 851. For example, the controller 851 may perform the division and joint training by performing functions of the units in the electronic apparatus 100.

### APPLICATION EXAMPLE OF USER EQUIPMENT

### First Application Example

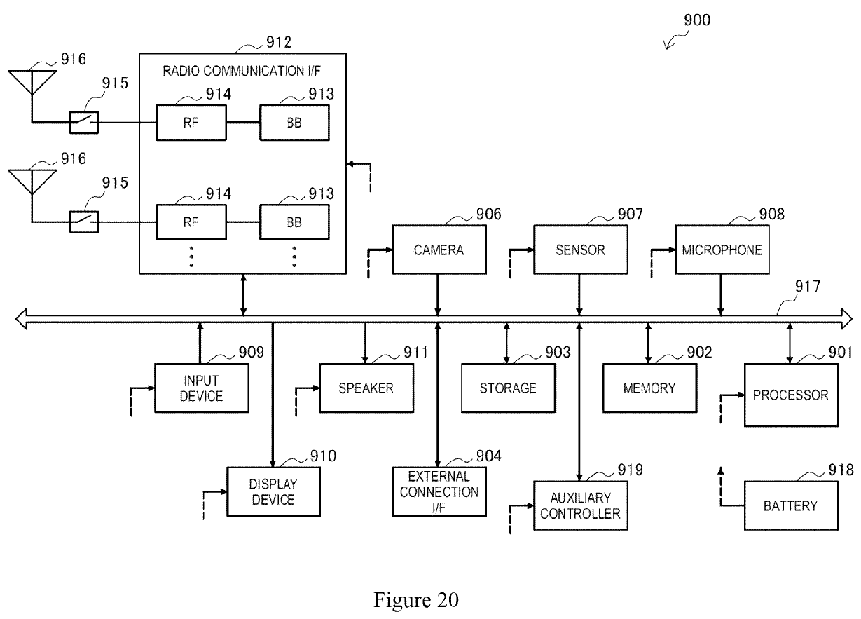

FIG. 20 is a block diagram showing an example of a schematic configuration of a smart phone 900 to which the technology of the present disclosure is applicable. The smart phone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on chip (SoC), and controls functions of the application layer and other layers of the smart phone 900. The memory 902 includes an RAM and an ROM, and stores data and programs executed by the processor 901. The storage 903 may include a storage medium, such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter and an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 20, the radio communication interface 912 may include multiple BB processors 913 and multiple RF circuits 914. Although FIG. 20 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 20, the smart phone 900 may include multiple antennas 916. Although FIG. 20 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 20 via a feeder line. The feeder line is partially shown as a dashed line in the figure. The auxiliary controller 919 operates the least necessary function of the smart phone 900 in a sleep mode, for example.

In the smart phone 900 as shown in FIG. 20, in a case where the electronic apparatuses 600 is implemented, for example, as a smart phone on the user equipment side, the transceiver of the electronic apparatus 600 may be implemented by the radio communication interface 912. At least part of the functions may be implemented by the processor 901 or the auxiliary controller 919. For example, the processor 901 or the auxiliary controller 919 may report channel information of the sidelink by performing the function of the unit in the electronic apparatus 600.

### Second Application Example

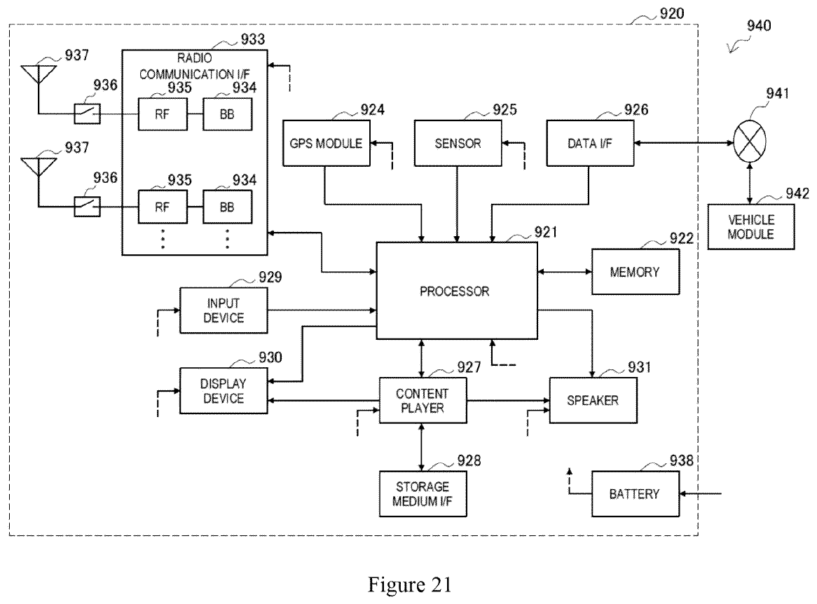

FIG. 21 is a block diagram showing an example of a schematic configuration of an automobile navigation device 920 to which the technology of the present disclosure is applicable. The automobile navigation device 920 includes a processor 921, a memory 922, a global positioning system (GPS) module 924, a sensor 925, a data interface 926, a content player 97, a storage medium interface 928, an input device 99, a display device 930, a speaker 931, a radio communication interface 913, one or more antenna switches 936, one or more antennas 937, and a battery 938.

The processor 921 may be, for example, a CPU or SoC, and controls the navigation function and other functions of the automobile navigation device 920. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 97 reproduces content stored in a storage medium (such as a CD and a DVD) inserted into the storage medium interface 928. The input device 99 includes, for example, a touch sensor configured to detect a touch on a screen of the display device 930, a button, or a switch, and receives an operation or information inputted from the user. The display device 930 includes a screen such as an LCD or OLED display, and displays an image of a navigation function or reproduced content. The speaker 931 outputs a sound of the navigation function or the reproduced content.

The radio communication interface 913 supports any cellular communication scheme (such as LTE and LTE-Advanced), and performs wireless communications. The radio communication interface 913 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter and an amplifier, and transmit and receive a wireless signal via the antenna 937. The radio communication interface 913 may be a chip module on which the BB processor 934 and the RF circuit 935 are integrated. As shown in FIG. 21, the radio communication interface 913 may include multiple BB processors 934 and multiple RF circuits 935. Although FIG. 21 shows an example in which the radio communication interface 913 includes multiple BB processors 934 and multiple RF circuits 935, the radio communication interface 913 may include a single BB processor 934 or a single RF circuit 935.

In addition to the cellular communication scheme, the radio communication interface 913 may support another type of wireless communication scheme, such as a short-range wireless communication scheme, a near field communication scheme, or a wireless LAN scheme. In this case, the radio communication interface 913 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 913.

Each of the antennas 937 includes a single or multiple antenna elements (such as multiple antenna elements included in a MIMO antenna), and is configured for the radio communication interface 913 to transmit and receive wireless signals. As shown in FIG. 21, the automobile navigation device 920 may include multiple antennas 937. Although FIG. 21 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 21 via a feeder line. The feeder line is partially shown as a dashed line in the figure. The battery 938 accumulates electric power supplied from the vehicle.

In the automobile navigation device 920 as shown in FIG. 21, in a case where the electronic apparatuses 600 is implemented, for example, as an automobile navigation device on the user equipment side, the transceiver of the electronic apparatus 600 may be implemented by the radio communication interface 933. At least part of the functions may be implemented by the processor 921. For example, the processor 921 may report channel information of the sidelink by performing the function of the unit in the electronic apparatus 600.

The technology of the present disclosure may be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with the specific embodiments. However, it should be noted that those skilled in the art can understand that all or any of steps or components of the methods and apparatuses of the present disclosure may be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the method according to any of the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

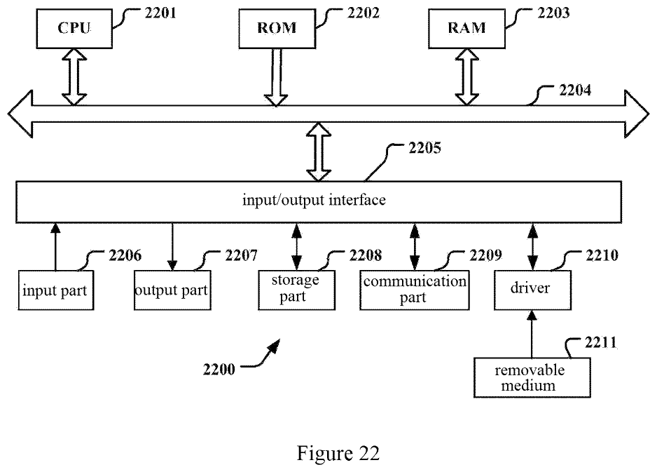

In a case of implementing the embodiments of the present disclosure in software or firmware, the program consisting of the software is mounted to a computer with a dedicated hardware structure (such as a general-purpose computer 2200 as shown in FIG. 22) from the storage medium or network. The computer, when mounted with various programs, performs various functions.

In FIG. 22, a central processing unit (CPU) 2201 executes various processes according to a program stored in a read-only memory (ROM) 2202 or a program loaded from a storage part 2208 to a random access memory (RAM) 2203. In the RAM 2203, data required for the CPU 2201 to perform various processes or the like is stored as necessary. The CPU 2201, the ROM 2202 and the RAM 2203 are connected to each other via a bus 2204. An input/output interface 2205 is connected to the bus 2204.

The following components are connected to the input/output interface 2205: an input part 2206 (including a keyboard, a mouse, and the like), an output part 2207 (including a display, such as a cathode ray tube (CRT) and a liquid crystal display (LCD), a loudspeaker, and the like), a storage part 2208 (including a hard disk and the like), and a communication part 2209 (including a network interface card, such as a LAN card, and a modem). The communication part 2209 performs communication processing via a network, such as the Internet. A driver 2210 may be connected to the input/output interface 2205 as needed. A removable medium 2211, such as a magnetic disk, an optical disk, a magnetic optical disk, and a semiconductor memory, is mounted to the driver 2210 as required, so that a computer program read therefrom is mounted to the storage part 2208 as required.

In a case that the above processes are implemented by software, the program consisting the software is mounted from a network, such as the Internet, or from a storage medium, such as the removable medium 2211.

Those skilled in the art should understood that, the storage medium is not limited to the removable medium 2211, as shown in FIG. 22, which stores a program and is distributed separately from the device so as to provide the program for a user. Examples of the removable medium 2211 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 2202, the hard disk contained in the storage part 2208, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a (n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.

Solution 1. An electronic apparatus for wireless communications, comprising:
processing circuitry configured to:
control, based on capability of a node among a plurality of nodes involved in a predetermined task and/or the electronic apparatus, at least one of access of the node in the predetermined task, exit of the node in the predetermined task, and switching of the electronic apparatus in the predetermined task.

Solution 2. The electronic apparatus according to solution 1, wherein
the predetermined task comprises a federated learning task, and
the processing circuitry is configured to: send, in each round of the federated learning task, a result of a total task in a previous round to the plurality of nodes, for the plurality of nodes to perform respective subtasks; and
integrate based on results of respective subtasks reported by the plurality of nodes respectively, to obtain an integrated result as an updated result of the total task in a current round.

Solution 3. The electronic apparatus according to solution 1, wherein
the predetermined task comprises a distributed task, and
the processing circuitry is configured to:
split a total task in the distributed task into a plurality of subtasks;
send, in an initial round, an initial result of the total task to the plurality of nodes;
send, in each round rather than the initial round, a result of the total task in a previous round to the plurality of nodes, for the plurality of nodes to perform respective subtasks; and
integrate based on results of respective subtasks reported by the plurality of nodes respectively, to obtain an integrated result as an updated result of the total task in a current round.

Solution 4. The electronic apparatus according to solution 2 or 3, wherein the capability of the node and/or the electronic apparatus is characterized by time information about the node and/or the electronic apparatus.

Solution 5. The electronic apparatus according to solution 4, wherein the processing circuitry is configured to: in response to a switching request for the switching issued by the electronic apparatus, perform the control based on a remaining control time length of the electronic apparatus in a current round included in the time information, to determine when the electronic apparatus switches to not perform the control in the predetermined task,
wherein the remaining control time length is equal to a small one of a remaining service time length from a current time instant to a time instant when the electronic apparatus no longer performs the control and a time length from a current time instant to an end time instant of a current control cycle of the electronic apparatus.

Solution 6. The electronic apparatus according to solution 5, wherein the processing circuitry is configured to perform the determination further based on a first time length and a second time length included in the time information, the first time length referring to a time length from a current time instant to a time instant when the electronic apparatus completes integration in a next round, and the second time length referring to a time length from a current time instant to a time instant when the electronic apparatus completes integration in a current round.

Solution 7. The electronic apparatus according to solution 6, wherein the processing circuitry is configured to determine that the electronic apparatus does not perform the switching before completion of integration in the next round, in a case where the remaining control time length is greater than or equal to the first time length.

Solution 8. The electronic apparatus according to solution 6, wherein the processing circuitry is configured to determine that the electronic apparatus performs the switching immediately after completion of integration in a current round, in a case where the remaining control time length is greater than the second time length and less than the first time length.

Solution 9. The electronic apparatus according to solution 6, wherein the processing circuitry is configured to extend the remaining service time length in a case where the remaining control time length is less than or equal to the second time length, through at least one of the following manners: increasing a transmitted power of the electronic apparatus, reducing a reference signal received power (RSRP) threshold of the electronic apparatus, and allocating more communication resources to the electronic apparatus.

Solution 10. The electronic apparatus according to solution 9, wherein
the processing circuitry is configured to determine that the electronic apparatus performs the switching during an extended remaining control time length from a current time instant, in a case where the extended remaining control time length is less than or equal to the second time length.

Solution 11. The electronic apparatus according to solution 10, wherein
after the electronic apparatus performs the switching, a node configured for performing the control in the predetermined task broadcasts an instruction to the plurality of nodes requiring the plurality of nodes to report results of respective subtasks, to receive the results of the respective subtasks from the plurality of nodes.

Solution 12. The electronic apparatus according to solution 9, wherein
the processing circuitry is configured to determine that the electronic apparatus performs the switching immediately after completion of integration in a current round, in a case where an extended remaining control time length is greater than the second time length.

Solution 13. The electronic apparatus according to any one of solutions 4 to 12, wherein
the processing circuitry is configured to: in response to an access request for the access issued by an node to be accessed tending to access the predetermined task, perform the control based on a maximum waiting time length acceptable for the node to be accessed to access the predetermined task included in the time information, to determine when the node to be accessed performs the access.

Solution 14. The electronic apparatus according to solution 13, wherein
the processing circuitry is configured to perform the determination further based on a third time length included in the time information, the third time length referring to a time length from a time instant when the node to be accessed issues the access request to a time instant when the electronic apparatus completes integration in a current round.

Solution 15. The electronic apparatus according to solution 14, wherein
the processing circuitry is configured to determine that the node to be accessed performs the access after the electronic apparatus completes integration in a current round and before the electronic apparatus broadcasts an integrated result in a current round, in a case where the maximum waiting time length is greater than or equal to the third time length.

Solution 16. The electronic apparatus according to solution 15, wherein
the processing circuitry is configured to broadcast an integrated result in a current round after the node to be accessed performs the access.

Solution 17. The electronic apparatus according to solution 13, wherein the processing circuitry is configured to: in a case where the maximum waiting time length is less than the third time length, during a period of the maximum waiting time length from a time instant when the node to be accessed issues the access request, issue an instruction requiring all nodes participating in the predetermined task to report results of respective subtasks in a current round at a time instant of receipt of the instruction, receive results of respective subtasks in the current round reported by all nodes participating in the predetermined task, and determine that the node to be accessed performs the access during the period, and after the electronic apparatus completes integration in the current round and before the electronic apparatus broadcasts an integrated result in the current round.

Solution 18. The electronic apparatus according to solution 17, wherein
the processing circuitry is configured to broadcast an integrated result in the current round after the node to be accessed performs the access.

Solution 19. The electronic apparatus according to solution 13, wherein the processing circuitry is configured to: in a case where the maximum waiting time length is less than the third time length, determine that the node to be accessed performs the access during the maximum waiting time length from a time instant of issuing the access request, and deliver an integrated result in a previous round to the node to be accessed.

Solution 20. The electronic apparatus according to any one of solutions 4 to 19, wherein
the processing circuitry is configured to: in response to an exit request for the exit issued by a node to be exited tending to exit the predetermined task, perform the control based on a disconnection waiting time length from a time instant when the node to be exited issues the exit request to a time instant when the node to be exited is unable to participate in the predetermined task included in the time information, to determine when the node to be exited performs the exit.

Solution 21. The electronic apparatus according to solution 20, wherein the processing circuitry is configured to determine when the node to be exited performs the exit further based on a fourth time length and a fifth time length, the fourth time length referring to a time length from a time instant when the node to be exited issues the exit request to a time instant when the node to be exited completes reporting of results of respective subtasks in a next round, and the fifth time length referring to a time length from a time instant when the node to be exited issues the exit request to a time instant when the node to be exited completes reporting of results of respective subtasks in a current round.

Solution 22. The electronic apparatus according to solution 21, wherein the processing circuitry is configured to: determine that the node to be exited does not perform the exit before completion of reporting results of respective subtasks in a next round, in a case where the disconnection waiting time length is greater than or equal to the fourth time length.

Solution 23. The electronic apparatus according to solution 21, wherein the processing circuitry is configured to: determine that the node to be exited performs the exit after completion of reporting results of respective subtasks in a current round, in a case where the disconnection waiting time length is greater than the fifth time length and less than the fourth time length.

Solution 24. The electronic apparatus according to solution 21, wherein the processing circuitry is configured to delay the disconnection waiting time length in a case where the disconnection waiting time length is less than or equal to the fifth time length, by delaying the time instant when the node to be exited is unable to participate in the predetermined task through at least one of the following manners: increasing a transmitted power of the node to be exited, reducing a reference signal received power RSRP threshold of the node to be exited, and allocating more communication resources to the node to be exited.

Solution 25. The electronic apparatus according to solution 24, wherein the processing circuitry is configured to: in a case where the delayed disconnection waiting time length is less than or equal to the fifth time length, issue an instruction requiring all nodes participating in the predetermined task to report results of respective subtasks in a current round at a time instant of receipt of the instruction; during a period of the delayed disconnection waiting time length from a time instant when the node to be exited issues the exit request, receive results of respective subtasks in a current round reported by all nodes participating in the predetermined task, and determine that the node to be exited performs the exit after completion of reporting results of respective subtasks in a current round.

Solution 26. The electronic apparatus according to solution 24, wherein the processing circuitry is configured to: in a case where the delayed disconnection waiting time length is less than or equal to the fifth time length, issue an instruction requiring the node to be exited to report results of respective subtasks in a current round at a time instant of receipt of the instruction, and determine that the node to be exited performs the exit after completion of reporting results of respective subtasks in a current round.

Solution 27. The electronic apparatus according to solution 24, wherein the processing circuitry is configured to: determine that the node to be exited performs the exit after completion of reporting results of respective subtasks in a current round, in a case where the delayed disconnection waiting time length is greater than the fifth time length.

Solution 28. The electronic device according to any one of solutions 4 to 27, wherein the time information about a node and/or the electronic apparatus is estimated based on at least one of channel state information, location information, battery level, and computing capability of the node and/or the electronic apparatus.

Solution 29. The electronic apparatus according to any one of solutions 1 to 3, wherein the capability of the node and/or the electronic apparatus is characterized by battery level information of the node and/or the electronic apparatus.

Solution 30. The electronic apparatus according to claim any one of solutions 1 to 3, wherein the capability of the node and/or the electronic apparatus is characterized by location information of the node and/or the electronic apparatus.

Solution 31. The electronic apparatus according to any one of solutions 4 to 30, wherein the processing circuitry is configured to deliver a result of the control to the node via a Uu port in a case where the federated learning is in a centralized mode in which the electronic apparatus is a base station.

Solution 32. The electronic apparatus according to any one of solutions 4 to 30, wherein the processing circuitry is configured to deliver a result of the control to the node via a PC5 port in a case where the federated learning is in a centralized mode in which the electronic apparatus is a roadside apparatus or a vehicle-mounted apparatus.

Solution 33. The electronic apparatus according to any one of solutions 4 to 30, wherein the processing circuitry is configured to deliver a result of the control to the node via a PC5 port in a case where the federated learning has a peer-to-peer structure.

Solution 34. The electronic apparatus according to any one of solutions 1 to 33, wherein the processing circuitry is configured to receive information about the capability from the node periodically or through event triggering.

Solution 35. The electronic apparatus according to solution 34, wherein the event triggering comprises that a battery level of the node is lower than a predetermined threshold.

Solution 36. The electronic apparatus according to any one of solutions 1 to 35, wherein the predetermined task comprises beam selection or usage of resources in a resource pool.

Solution 37. An electronic apparatus for wireless communications, comprising: processing circuitry configured to:
report capability of the electronic apparatus to a central node in a predetermined task in which the electronic apparatus is involved, for the central node to control access and/or exit of the electronic apparatus in the predetermined task.

Solution 38. The electronic apparatus according to solution 37, wherein
the predetermined task comprises a federated learning task, and
the processing circuitry is configured to: receive, in each round of the federated learning task, a result of a total task in a previous round from the central node to perform respective subtasks; and report results of respective subtasks to the central node, for the central node to integrate based on results of the subtasks to obtain an integrated result as an updated result of the total task in a current round.

Solution 39. The electronic apparatus according to solution 37, wherein
the predetermined task comprises a distributed task, and
the processing circuitry is configured to: receive, in each round, a result of a total task in a previous round from the central node to perform respective subtasks; and report results of respective subtasks to the central node, for the central node to integrate based on results of the subtasks to obtain an integrated result as an updated result of the total task in a current round.

Solution 40. The electronic apparatus according to solution 38 or 39, wherein the capability is characterized by time information about the electronic apparatus.

Solution 41. The electronic apparatus according to solution 40, wherein
the processing circuitry is configured to: issue an access request for the access to the central node, for the central node to perform the control based on a maximum waiting time length acceptable for the electronic apparatus to access the predetermined task included in the time information, to make a decision when the electronic apparatus performs the access.

Solution 42. The electronic apparatus according to solution 41, wherein
the time information further comprises a third time length, referring to a time length from a time instant when the electronic apparatus issues the access request to a time instant when the central node completes integration in a current round.

Solution 43. The electronic apparatus according to solution 42, wherein
the processing circuitry is configured to receive, from the central node, a decision that: the electronic apparatus performs the access after the central node completes integration in a current round and before the central node broadcasts an integrated result in a current round, in a case where the maximum waiting time length is greater than or equal to the third time length.

Solution 44. The electronic apparatus according to solution 43, wherein
the processing circuitry is configured to receive, after performing the access, an integrated result in a current round broadcast by the central node.

Solution 45. The electronic apparatus according to solution 42, wherein the processing circuitry is configured to receive, from the central node, a decision that: in a case where the maximum waiting time length is less than the third time length, during a period of the maximum waiting time length from a time instant when the electronic apparatus issues the access request, the central node issues an instruction requiring all nodes participating in the predetermined task to report results of respective subtasks in a current round at a time instant of receipt of the instruction, receives results of respective subtasks in a current round reported by all nodes participating in the predetermined task, and the electronic apparatus performs the access during the period, and after the central node completes integration in a current round and before the central node broadcasts an integrated result in a current round.

Solution 46. The electronic apparatus according to solution 45, wherein
the processing circuitry is configured to broadcast an integrated result in a current round after the electronic apparatus performs the access.

Solution 47. The electronic apparatus according to solution 42, wherein the processing circuitry is configured to receive, from the central node, a decision that: in a case where the maximum waiting time length is less than the third time length, the electronic apparatus performs the access during the maximum waiting time length from a time instant of issuing the access request, and receives an integrated result in a previous round from the central node.

Solution 48. The electronic apparatus according to any one of solutions 40 to 47, wherein
the processing circuitry is configured to: issue an exit request for the exit to the central node, for the central node to perform the control based on a disconnection waiting time length from a time instant when the electronic apparatus issues the exit request to a time instant when the electronic apparatus is unable to participate in the predetermined task included in the time information, to determine when the electronic apparatus performs the exit.

Solution 49. The electronic apparatus according to solution 48, wherein the time information further comprises a fourth time length and a fifth time length, the fourth time length referring to a time length from a time instant when the electronic apparatus issues the exit request to a time instant when the electronic apparatus completes reporting of results of respective subtasks in a next round, and the fifth time length referring to a time length from a time instant when the electronic apparatus issues the exit request to a time instant when the electronic apparatus completes reporting of results of respective subtasks in a current round.

Solution 50. The electronic apparatus according to claim 49, wherein the processing circuitry is configured to receive, from the central node, a decision that: the electronic apparatus does not perform the exit before completion of reporting results of respective subtasks in a next round, in a case where the disconnection waiting time length is greater than or equal to the fourth time length.

Solution 51. The electronic apparatus according to solution 49, wherein the processing circuitry is configured to receive, from the central node, a decision that: the electronic apparatus performs the exit after completion of reporting results of respective subtasks in a current round, in a case where the disconnection waiting time length is greater than the fifth time length and less than the fourth time length.

Solution 52. The electronic apparatus according to solution 49, wherein the disconnection waiting time length is delayed in a case where the disconnection waiting time length is less than or equal to the fifth time length, by delaying the time instant when the electronic apparatus is unable to participate in the predetermined task through at least one of the following manners: increasing a transmitted power of the electronic apparatus, reducing a reference signal received power (RSRP) threshold of the electronic apparatus, and allocating more communication resources to the electronic apparatus.

Solution 53. The electronic apparatus according to solution 52, wherein the processing circuitry is configured to receive, from the central node, a decision that: in a case where the delayed disconnection waiting time length is less than or equal to the fifth time length, during a period of the delayed disconnection waiting time length from a time instant when the electronic apparatus issues the exit request, the central node issues an instruction requiring all nodes participating in the predetermined task to report results of respective subtasks in a current round at a time instant of receipt of the instruction, receives results of respective subtasks in a current round reported by all nodes participating in the predetermined task, and the electronic apparatus performs the exit after completion of reporting results of respective subtasks in a current round.

Solution 54. The electronic apparatus according to solution 52, wherein the processing circuitry is configured to receive, from the central node, a decision that: in a case where the delayed disconnection waiting time length is less than or equal to the fifth time length, the central node issues an instruction requiring the electronic apparatus to report results of respective subtasks in a current round at a time instant of receipt of the instruction, and the electronic apparatus performs the exit after completion of reporting results of respective subtasks in a current round.

Solution 55. The electronic apparatus according to solution 52, wherein the processing circuitry is configured to receive, from the central node, a decision that: the electronic apparatus performs the exit after completion of reporting results of respective subtasks in a current round, in a case where the delayed disconnection waiting time length is greater than the fifth time length.

Solution 56. The electronic device according to any one of solutions 40 to 55, wherein the time information is estimated based on at least one of channel state information, location information, battery level, and computing capability of the electronic apparatus.

Solution 57. The electronic apparatus according to any one of solutions 37 to 39, wherein the capability of the electronic apparatus is characterized by battery level information or location information of the electronic apparatus.

Solution 58. The electronic apparatus according to any one of solutions 40 to 57, wherein the processing circuitry is configured to receive a result of the control from the central node via a Uu port in a case where the federated learning is in a centralized mode in which the central node is a base station.

Solution 59. The electronic apparatus according to any one of solutions 40 to 57, wherein the processing circuitry is configured to receive a result of the control from the central node via a PC5 port in a case where the federated learning is in a centralized mode in which the central node is a roadside apparatus or a vehicle-mounted apparatus.

Solution 60. The electronic apparatus according to any one of solution 40 to 57, wherein the processing circuitry is configured to receive a result of the control from the central node via a PC5 port in a case where the federated learning has a peer-to-peer structure.

Solution 61. The electronic apparatus according to any one of solutions 37 to 60, wherein the processing circuitry is configured to report information about the capability to the central node periodically or through event triggering.

Solution 62. The electronic apparatus according to solution 61, wherein the event triggering comprises that a battery level of the electronic apparatus is lower than a predetermined threshold.

Solution 63. The electronic apparatus according to any one of solutions 37 to 62, wherein the predetermined task comprises beam selection or usage of resources in a resource pool.

Solution 64. A method for wireless communications, comprising:
controlling, by an electronic apparatus based on capability of a node among a plurality of nodes involved in a predetermined task and/or the electronic apparatus, at least one of access of the node in the predetermined task, exit of the node in the predetermined task, and switching of the electronic apparatus in the predetermined task.

Solution 65. A method for wireless communications, comprising:
reporting capability of an electronic apparatus to a central node in a predetermined task in which the electronic apparatus is involved, for the central node to control access and/or exit of the electronic apparatus in the predetermined task.

Solution 66. A computer-readable storage medium storing computer-executable instructions, when being executed, for performing the method for wireless communications according to solution 64 or 65.

1. An electronic apparatus for wireless communications, comprising:
at least one processor; and
at least one memory including computer program code, where the at least one memory and the computer program code are configured, with the at least one processor, to cause the electronic apparatus to at least:
control, based on capability of a node among a plurality of nodes involved in a predetermined task and/or the electronic apparatus, at least one of access of the node in the predetermined task, exit of the node in the predetermined task, and switching of the electronic apparatus in the predetermined task.

2. The electronic apparatus according to claim 1, wherein
the predetermined task comprises a federated learning task, and
the at least one memory and the computer program code are configured, with the at least one processor, to cause the electronic apparatus to: send, in each round of the federated learning task, a result of a total task in a previous round to the plurality of nodes, for the plurality of nodes to perform respective subtasks; and
integrate based on results of respective subtasks reported by the plurality of nodes respectively, to obtain an integrated result as an updated result of the total task in a current round.

3. The electronic apparatus according to claim 1, wherein
the predetermined task comprises a distributed task, and
the at least one memory and the computer program code are configured, with the at least one processor, to cause the electronic apparatus to:
split a total task in the distributed task into a plurality of subtasks:
send, in an initial round, an initial result of the total task to the plurality of nodes:
send, in each round rather than the initial round, a result of the total task in a previous round to the plurality of nodes, for the plurality of nodes to perform respective subtasks; and
integrate based on results of respective subtasks reported by the plurality of nodes respectively, to obtain an integrated result as an updated result of the total task in a current round.

4. The electronic apparatus according to claim 2, wherein the capability of the node and/or the electronic apparatus is characterized by time information about the node and/or the electronic apparatus.

5. The electronic apparatus according to claim 4, wherein the at least one memory and the computer program code are configured, with the at least one processor, to cause the electronic apparatus to: in response to a switching request for the switching issued by the electronic apparatus, perform the control based on a remaining control time length of the electronic apparatus in a current round included in the time information, to determine when the electronic apparatus switches to not perform the control in the predetermined task,
wherein the remaining control time length is equal to a small one of a remaining service time length from a current time instant to a time instant when the electronic apparatus no longer performs the control and a time length from a current time instant to an end time instant of a current control cycle of the electronic apparatus.

6. The electronic apparatus according to claim 5, wherein the at least one memory and the computer program code are configured, with the at least one processor, to cause the electronic apparatus to perform the determination further based on a first time length and a second time length included in the time information, the first time length referring to a time length from a current time instant to a time instant when the electronic apparatus completes integration in a next round, and the second time length referring to a time length from a current time instant to a time instant when the electronic apparatus completes integration in a current round.

7. The electronic apparatus according to claim 6, wherein the at least one memory and the computer program code are configured, with the at least one processor, to cause the electronic apparatus to determine that the electronic apparatus does not perform the switching before completion of integration in the next round, in a case where the remaining control time length is greater than or equal to the first time length, or
wherein the at least one memory and the computer program code are configured, with the at least one processor, to cause the electronic apparatus to determine that the electronic apparatus performs the switching immediately after completion of integration in a current round, in a case where the remaining control time length is greater than the second time length and less than the first time length.

8. (canceled)

9. The electronic apparatus according to claim 6, wherein the at least one memory and the computer program code are configured, with the at least one processor, to cause the electronic apparatus to extend the remaining service time length in a case where the remaining control time length is less than or equal to the second time length, through at least one of the following manners: increasing a transmitted power of the electronic apparatus, reducing a reference signal received power (RSRP) threshold of the electronic apparatus, and allocating more communication resources to the electronic apparatus.

10. The electronic apparatus according to claim 9, wherein
the at least one memory and the computer program code are configured, with the at least one processor, to cause the electronic apparatus to determine that the electronic apparatus performs the switching during an extended remaining control time length from a current time instant, in a case where the extended remaining control time length is less than or equal to the second time length.

11. (canceled)

12. The electronic apparatus according to claim 9, wherein
the at least one memory and the computer program code are configured, with the at least one processor, to cause the electronic apparatus to determine that the electronic apparatus performs the switching immediately after completion of integration in a current round, in a case where an extended remaining control time length is greater than the second time length.

13. The electronic apparatus according to claim 4, wherein
the at least one memory and the computer program code are configured, with the at least one processor, to cause the electronic apparatus to: in response to an access request for the access issued by an node to be accessed tending to access the predetermined task, perform the control based on a maximum waiting time length acceptable for the node to be accessed to access the predetermined task included in the time information, to determine when the node to be accessed performs the access.

14. The electronic apparatus according to claim 13, wherein
the at least one memory and the computer program code are configured, with the at least one processor, to cause the electronic apparatus to perform the determination further based on a third time length included in the time information, the third time length referring to a time length from a time instant when the node to be accessed issues the access request to a time instant when the electronic apparatus completes integration in a current round.

15. The electronic apparatus according to claim 14, wherein
the at least one memory and the computer program code are configured, with the at least one processor, to cause the electronic apparatus to determine that the node to be accessed performs the access after the electronic apparatus completes integration in a current round and before the electronic apparatus broadcasts an integrated result in a current round, in a case where the maximum waiting time length is greater than or equal to the third time length.

16. (canceled)

17. The electronic apparatus according to claim 14, wherein the at least one memory and the computer program code are configured, with the at least one processor, to cause the electronic apparatus to: in a case where the maximum waiting time length is less than the third time length, during a period of the maximum waiting time length from a time instant when the node to be accessed issues the access request, issue an instruction requiring all nodes participating in the predetermined task to report results of respective subtasks in a current round at a time instant of receipt of the instruction, receive results of respective subtasks in the current round reported by all nodes participating in the predetermined task, and determine that the node to be accessed performs the access during the period, and after the electronic apparatus completes integration in the current round and before the electronic apparatus broadcasts an integrated result in the current round.

18. (canceled)

19. The electronic apparatus according to claim 14, wherein the at least one memory and the computer program code are configured, with the at least one processor, to cause the electronic apparatus to: in a case where the maximum waiting time length is less than the third time length, determine that the node to be accessed performs the access during the maximum waiting time length from a time instant of issuing the access request, and deliver an integrated result in a previous round to the node to be accessed.

20. The electronic apparatus according to claim 4, wherein
the at least one memory and the computer program code are configured, with the at least one processor, to cause the electronic apparatus to: in response to an exit request for the exit issued by a node to be exited tending to exit the predetermined task, perform the control based on a disconnection waiting time length from a time instant when the node to be exited issues the exit request to a time instant when the node to be exited is unable to participate in the predetermined task included in the time information, to determine when the node to be exited performs the exit.

21. The electronic apparatus according to claim 20, wherein the at least one memory and the computer program code are configured, with the at least one processor, to cause the electronic apparatus to determine when the node to be exited performs the exit further based on a fourth time length and a fifth time length, the fourth time length referring to a time length from a time instant when the node to be exited issues the exit request to a time instant when the node to be exited completes reporting of results of respective subtasks in a next round, and the fifth time length referring to a time length from a time instant when the node to be exited issues the exit request to a time instant when the node to be exited completes reporting of results of respective subtasks in a current round.

22. The electronic apparatus according to claim 21, wherein the at least one memory and the computer program code are configured, with the at least one processor, to cause the electronic apparatus to: determine that the node to be exited does not perform the exit before completion of reporting results of respective subtasks in a next round, in a case where the disconnection waiting time length is greater than or equal to the fourth time length, or
wherein the at least one memory and the computer program code are configured, with the at least one processor, to cause the electronic apparatus to: determine that the node to be exited performs the exit after completion of reporting results of respective subtasks in a current round, in a case where the disconnection waiting time length is greater than the fifth time length and less than the fourth time length, or
wherein the at least one memory and the computer program code are configured, with the at least one processor, to cause the electronic apparatus to delay the disconnection waiting time length in a case where the disconnection waiting time length is less than or equal to the fifth time length, by delaying the time instant when the node to be exited is unable to participate in the predetermined task through at least one of the following manners: increasing a transmitted power of the node to be exited, reducing a reference signal received power (RSRP) threshold of the node to be exited, and allocating more communication resources to the node to be exited.

23.-36. (canceled)

37. An electronic apparatus for wireless communications, comprising:
at least one processor; and
at least one memory including computer program code, where the at least one memory and the computer program code are configured, with the at least one processor, to cause the electronic apparatus to at least:
report capability of the electronic apparatus to a central node in a predetermined task in which the electronic apparatus is involved, for the central node to control access and/or exit of the electronic apparatus in the predetermined task.

38.-63. (canceled)

64. A method for wireless communications, comprising:
controlling, by an electronic apparatus based on capability of a node among a plurality of nodes involved in a predetermined task and/or the electronic apparatus, at least one of access of the node in the predetermined task, exit of the node in the predetermined task, and switching of the electronic apparatus in the predetermined task.

65.-66. (canceled)
